(19) United States
(12) Patent Application Publication
(10) Pub. No.: US 2013/0300761 A1
(43) Pub. Date: Nov. 14, 2013

(54) METHOD AND SYSTEM FOR COLOR MATCHING AND COLOR RECOMMENDATION

(71) Applicant: Asmau Ahmed, Stamford, CT (US)

(72) Inventor: Asmau Ahmed, Stamford, CT (US)

(73) Assignee: COLORMODULES INC., Stamford, CT (US)

(21) Appl. No.: 13/884,638

(22) PCT Filed: Nov. 11, 2011
(86) PCT No.: PCT/US11/60323

§ 371 Date: Jul. 22, 2013

Related U.S. Application Data
(60) Provisional application No. 61/413,363, filed on Nov. 12, 2010.

(51) Int. Cl. G09G 5/02

(52) U.S. Cl. CPC G09G 5/02
USPC 345/595

(57) ABSTRACT

A color matching and color recommendation system. In one embodiment, the system may (i) receive a color input indicative of one or more colors, (ii) select at least one reference color from the one or more colors, (iii) associate the at least one reference color with at least one of a plurality of predefined color categories, and (iv) identify at least one related color based on the at least one of the plurality of predefined color categories. In another embodiment, the system may (i) receive a color input indicative of one or more colors, (ii) select at least one reference color from the one or more colors, and (iii) compare the at least one reference color to a plurality of predetermined colors to identify one or more related colors having color data closest to the at least one reference color.

### CROSS REFERENCE TO RELATED APPLICATIONS

The present application claims the benefit of U.S. Provisional Application Ser. No. 61/413,363 filed 12 Nov. 2010; which is incorporated herein by reference in its entirety.

### FIELD OF THE INVENTION

This invention generally relates to color matching and coordination systems, and more particularly to color-based product search.

### BACKGROUND OF THE INVENTION

People use color as a primary criteria in many of their every day decisions, such as when shopping for clothing, cosmetics, and home decoration products. In addition, web-based retail industry has gained wide popularity in recent years. Many people enjoy the convenience of shopping on-line rather than visiting a store. On-line shopping, however, has some limitations when looking for products based on color criteria. A buyer may often have to navigate through a large volume of brands, products, etc. in an attempt to find one or more products having the desired color. Further, at best, a buyer will typically be presented with a digital “color swatch” of the product (e.g., a digital swatch of a cosmetic, fabric, paint color, etc.), and will have to make a judgment call whether the color in the image is a “true” color match or a color coordinate (i.e., a coordinating color (e.g., a related color that “complements,” or coordinates with, another color to create a desired color combination, such as color harmony/balance or color contrast).

Shopping on-line for cosmetics is particularly difficult. Female buyers, for example often struggle with selecting foundation, eye make-up, lipsticks, etc. that match or coordinate well with their natural features, such as their skin-tone color (or skin color), eye color, and/or hair color. Similarly, if a buyer wishes to find fashion-related products that will go “well” with her natural features, this may be particularly difficult with currently available systems. A buyer will often simply have to know in advance which colors will suit her. Proper color choices, however, are important because they will tend to enhance person's own natural colors, such as an eye color for example. Poor color choices, on the other hand, can blend with a person's natural colors to create a “washed out” look or create an excess contrast (such as a lipstick has too much red pigment, for instance).

Many retail websites merely provide a buyer with a palette of different available color shades for a given product. However, the final color selection has to be made by the buyer. For shopping convenience, retailers may also let a buyer select a product by its number (e.g., lipstick #25 or powder #60). However, product that the buyer used in the past, such as a blush for instance, may no longer suit the buyer if any of her natural colors have changed.

For example, during summer months, the buyer may be tanned, have hair highlights, etc., whereas during winter months, the buyer may tend to be more fair-complexioned, have a darker hair color, etc. Thus, selecting a given product based on its past use may not be an ideal way to buy matching or coordinating cosmetic(s). Product colors may also get discontinued, so that buyers will often need new product recommendations based on their individualized color profiles.

In-store shopping can be equally frustrating. In-store consultants may have limited skills and/or resources to find “matching” or coordinating products, and trial and error method is often the only way a buyer can hope to find suitable items, such as cosmetics and/or fashion products. In addition, when shopping for cosmetics for instance, in-store lightning conditions (e.g., florescent lights) may obscure person's natural colors and result in cosmetic purchases that may not be ideal color choices.

In-store or online shopping for home decoration items based on color presents its own set of problems. If a buyer wishes to find paint or other items to create certain “look” or coordinate differently-colored items, then the buyer will often simply have to guess which colors will render an aesthetically pleasing combination. With respect to paint color for example, most buyers these days have to rely on small paint color swatches in order to decide whether given paint color(s) will be suitable for painting a room or multiple rooms. Needless to say, such decisions may end up frustrating the buyer.

Aside from private buyers, industry professionals, such as manufacturers, retailers, dye makers, etc. often need color information at different stages of product development or to make color and/or sales predictions during various seasons. Interior designers are yet another group of professionals who have to make important color-based decisions and purchases in an effort to render desired “looks” for their clients.

A need, therefore, exists for a system that could address the above-noted shortcomings associated with color-based decision making and shopping.

### SUMMARY OF THE INVENTION

The present invention provides more intelligent and convenient means to customize and provide color and product matches and recommendations to users.

In particular, according to an embodiment of the present invention, a color matching and color recommendation system is provided. In one embodiment, the system may (i) receive a color input indicative of one or more colors, (ii) select at least one reference color from the one or more colors, (iii) associate the at least one reference color with at least one of a plurality of predefined color categories, and (iv) identify at least one related color based on the at least one of the plurality of predefined color categories. Further, the system may identify at least one item associated with the at least one related color.

In another embodiment, the system may (i) receive a color input indicative of one or more colors, (ii) select at least one reference color from the one or more colors, and (iii) compare the at least one reference color to a plurality of predetermined colors to identify one or more related colors having color data closest to the at least one reference color. Further, the system may identify at least one item associated with the one or more related colors.

Similarly, in one embodiment, a method for color recommendation is provided. The method may comprise (i) receiving a color input indicative of one or more colors, (ii) selecting at least one reference color from the one or more colors, (iii) associating the at least one reference color with at least one of a plurality of predefined color categories, and (iv) identifying at least one related color based on the at least one of the plurality of predefined color categories.

In another embodiment, a method for color matching is provided. The method may comprise (i) receiving a color input indicative of one or more colors, (ii) selecting at least one reference color from the one or more colors, and (iii) comparing the at least one reference color to a plurality of predetermined colors to identify one or more related colors having color data closest to the at least one reference color.

In yet another embodiment, a computerized method is provided. The method may comprise (i) receiving a color input indicative of at least a skin color of a given person, and (ii) automatically identifying one or more related colors based at least on the skin color of the given person.

### BRIEF DESCRIPTION OF THE DRAWINGS

The invention is described by example in what follows in reference to the enclosed drawings.

FIG. 1 shows an embodiment of a color system.

FIG. 2 shows a flow chart of one embodiment of a set of functions that could be carried out in accordance with the arrangement of FIG. 1.

FIG. 3 shows a family of skin colors (or “skintone” colors as shown) that were characterized as having a hue of 20 degrees.

FIG. 4 shows a corresponding color-categorization chart for the color family of FIG. 3.

FIG. 5 shows a family of skin colors (or “skintone” colors as shown) that were characterized as having a hue of 100 degrees.

FIG. 6 shows a corresponding color-categorization chart for the color family of FIG. 5.

FIG. 7 shows an embodiment of two color categories and corresponding colors that fall into those color categories.

FIG. 8 shows a color temperature scale and the associated level values.

FIG. 9 shows a value scale and the associated level values.

FIG. 10 shows a chroma scale and the associated level values.

FIG. 11 shows one embodiment of an application of the dominance system functionality.

FIG. 12 shows one embodiment of the operation of the matching section of the color system.

FIG. 13 shows one embodiment of the operation of the color-recommendation section of the color system.

FIG. 14 shows another embodiment of the operation of the color-recommendation section of the color system as used for matching shoes to a dress.

FIG. 15 shows another embodiment of the operation of the color-recommendation section of the color system as used for cosmetic products, such as a lipstick.

FIG. 16 shows another embodiment of a color system.

FIG. 17 shows an embodiment of functional components of a color system in a mobile device.

FIG. 18 shows an embodiment of functional components of a color system in a kiosk.

### DETAILED DESCRIPTION OF THE INVENTION

### General System Arrangement and Functionality

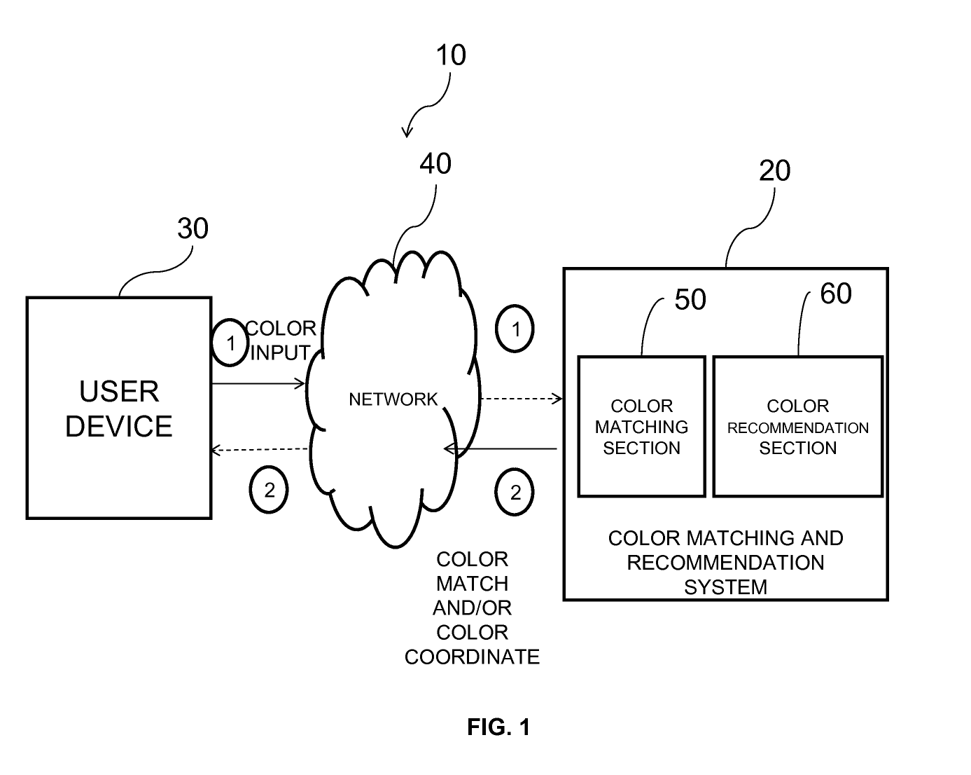

FIG. 1 illustrates a basic arrangement 10 in which an illustrative embodiment could be implemented. As shown in FIG. 1, arrangement 10 includes a user device 30 and a color matching-and-recommendation system 20 (hereinafter “color system 20” for short), coupled together by a network 40. As such, a user (not shown) could communicate with color system 20 (i.e., may submit/receive information to/from color system 20) over network 40 via user device 30. Additionally, as shown in FIG. 1, color system 20 includes a color-matching section 50 and a color-recommendation section 60.

User device 30 may be equipped with suitable user interface(s) (e.g., a keypad, a keyboard, touch screen, mouse, a microphone, a display, etc.) to facilitate interaction with the user, and could take on a variety of different forms, including, but not limited to landline computer(s) (e.g., a personal computer), wireless computer(s) (e.g., a laptop), handheld wireless/mobile device(s) (e.g. a mobile/cellular phone, personal digital assistant (PDA), a camera device, etc.), and/or any other suitable device(s).

Network 40 may be a wireless network, a landline network, or a combination of wireless and landline network(s) interconnected via appropriate interfaces and/or various network elements. In addition, network 40 may be a private network, a public network, or a combination of private and/or public networks. In one example, color system 20 may be deployed on a private network accessible to a user through a public network, such as the Internet and/or other private/public network(s) (e.g., a wireless carrier's network, local area network (LAN), wide area network (WAN), a wireless 802.11 LAN, WiFi, etc.). Of course, it is also possible that user device 30 and the color system may be deployed on the same network.

Note, however, that this and other arrangements described herein are provided by way of example only, and other arrangements and elements (e.g., machines, interfaces, functions, orders of elements, etc.) can be added or used instead and some elements may be omitted altogether. Further, those skilled in the art will also appreciate that many of the elements described herein are functional entities that may be implemented as discrete components or in conjunction with other components, in any suitable combination and location, and various functions could be carried out by software, firmware and/or hardware.

In a basic operation, in the arrangement in FIG. 1 for instance, color system 20 functions as a search tool providing color-matching and color-recommendation functionality. More specifically, color system 20 may receive a color input indicative of one or more colors. The system may then select at least one reference color from the one or more colors. In some embodiments, the system could associate the at least one reference color with at least one of a plurality of predefined color categories. The system may further identify at least one related color and/or item associated with the at least one related color.

As used herein, a “reference color” is generally a color used as a basis for identifying/finding matching and/or coordinating color(s)/item(s)). Also note that, as used herein, a “related color” generally refers to a color that is a matching color or a coordinating color to a reference color. Further, a “color coordinate” and “a coordinating color” are used interchangeably, and generally denote any related color that could be similar to or different from a reference color, and that “complements,” or coordinates with, the reference color to create a desired color combination, such as color harmony/balance or color contrast.

Yet further, a “matching color” generally denotes any related color that could be the same as a reference color or substantially close to the reference color, such as a color having color data within a certain tolerance range (e.g., within 0%-20% tolerance from color data of a reference color). In addition, a “matching color” could be a color with substantially close color data that also belongs to the same color family or color category as the reference color.

In the illustrative embodiment, color matching section 50 of color system 20 can identify related color(s) that match reference color(s) and/or item(s) associated with the matching color(s). Color-recommendation section 60, on the other hand, can identify related color(s) that coordinate with the reference color(s) and/or items associated with the coordinating colors. In some embodiments, the system may use at least one color category (or a corresponding descriptor(s) thereof) as a basis to identify the related color(s). Color system 20 may then provide an indication of the related color(s) or item(s) associated with the related color(s) to user device 30.

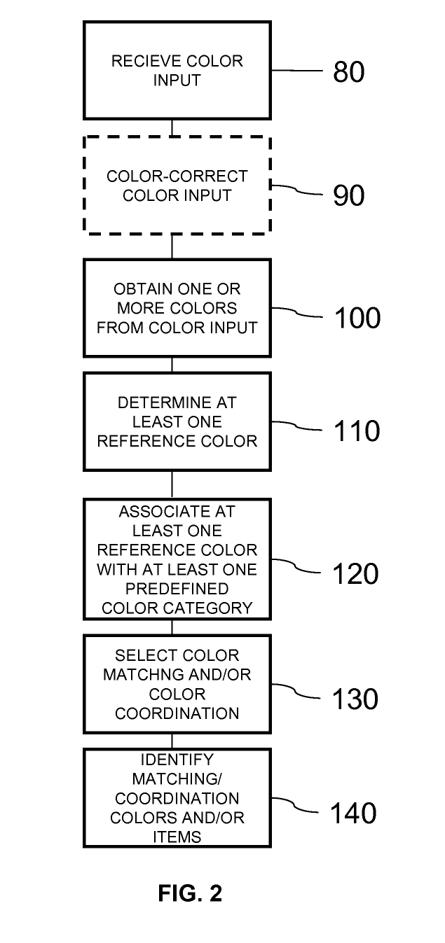

FIG. 2 is a flow chart generally illustrating an example set of functions that could be carried out in accordance with the arrangement of FIG. 1, for instance. In one example, color system 20 may include a processing system (e.g., implemented in the form of processor(s) and stored program instructions executed by the processor(s) (e.g., a processing system in a computerized system) that could be arranged to carry out such set of functions. The programming instructions may be stored on any type of media (e.g., computer-readable medium) now known or later developed, including magnetic, electronic and optical. This media refers to non-transitory media and not to signals, transmission lines, cables or airwaves. Such signals and transmission media are also available to transmit the stored instructions to the processor.

At step 80, color system 20 receives a color input from user device 30. The color input can be any of a numeric/alphanumeric entry representative of color, color-space parameters (as known in the art, e.g., HLS/HSL parameters, RGB parameters, XYZ parameters, CIELAB parameters, etc.) corresponding to color data, a picture/digital image, measurements from a color-measuring device (e.g., a spectrophotometer) and/or any other form of input indicative of one or more colors.

To illustrate, in one example, the color input can be a single or multiple digital images that a user can upload via user device 30 to color system 20. By way of example, if a user is looking for cosmetic products, the user may upload the image of a person's face. If a user is looking for fashion products, such as matching shoes, item(s) of clothing, and/or coordinating accessories(s), the user may submit image(s) of one or more pieces of clothing/fabric(s). In another example, the color input can be a combination of a digital image and color data entered via a suitable interface (such as a web-based interface) on the user device. In this regard, the color system 20 may include a color extraction subsystem or tool that allows users to upload images from which colors may be extracted. Various other examples are possible as well.

At step 90, color system 20 could be optionally configured to color-correct the color input. This function is particularly desirable if the color input includes a digital image or color coding from a color enhancement program or system. More particularly, digital images are normally captured under different light conditions and/or with different type or quality of equipment (e.g., digital cameras, mobile phone cameras, scanners, etc.). Thus, “true” color characteristics may often become lost.

As an example, excessive lighting can introduce glare effects and/or make the colors appear lighter than they actually are. In contrast, too little light can make the colors in the image appear darker. Advantageously, the color-correction function of color system 20 may be configured to remove any undesirable effects from the image. Various public and/or proprietary color-correcting algorithms may be used to carry out this function.

Note, however, that some color-correcting algorithms may use image enhancement techniques that change the actual original color characteristics of objects in an image. Preferably, in the illustrative embodiment, color system 20 will function to color-correct the input image such as to substantially preserve original color characteristics of object(s) in the input image. This would be particularly advantageous in connection with a color-matching functionality of color system 20. For example, when trying to find a matching foundation, color system 20 could preferably find a color match for a user's “true” skin color rather than an “enhanced” skin color. Any of the public and/or proprietary color processing algorithms currently available or later developed could potentially be used to carry out this function.

At step 100, color system 20 obtains one or more colors from the color input. In this regard, the system could obtain color information from the input by, for example, (i) reading entered color-space parameters, color measurement data, etc., (ii) measuring color(s) in the input using any suitable color-measuring device/software, and/or (iii) “extracting” one or more colors from the input digital image(s). Other ways may be possible as well.

In the case of a digital image for example, the image could be pixilated, and the system could read color data associated with individual pixels to determine presence of one or more colors in the image. The system could compute, for example, a number of pixels associated with each given color to determine predominating colors in the image. As an option, a user could select a given region of the image (e.g., a single pixel or a group of pixels if the image is pixilated prior to user selection), and the color(s) could be computed/extracted from the user-selected region or regions. In one example, the system could display the colors extracted from the image to a user, such as in the form of a color palette.

Step 110 then involves determining at least one reference color from the input color(s) for color match or color recommendation. In one example, the color input may correspond to a single color, such as a single set of color parameters/data (e.g., HLS parameters) or a digital image containing one color (e.g., a digital image of a fabric swatch or a single-colored item). As such, that single color would be used as a reference color. In another example, the color input could be a digital image containing multiple colors, and the system or a user could then select one or more colors to be used as reference color(s). Alternatively, the color input in form(s) other than a digital image may correspond to or define multiple colors or color parameters/data.

In the illustrative embodiment, a user will preferably have an option to specify a single reference color or multiple reference colors to serve as basis for finding matching and/or coordinating item(s)/color(s). In one example, the user could select one or more reference color(s) from colors extracted from the image (such as the color extracted from the user-selected region(s) and displayed to the user). In another example, the user could select one or more desired colors from a list or color palette identifying color(s) that were system-extracted from the image. In yet another example, given an image containing multiple colors, color system 20 could be configured to automatically determine a “dominant” color (as will be described later in more detail) to be used as a reference color. Other examples may be possible as well.

In accordance with the illustrative embodiment, to facilitate finding matching or coordinating colors/items, colors used for color matching and recommendation may be grouped into multiple distinct color categories that have been defined based on a combination of different characteristics (as will be described in more detail). As such, at step 120, color system 20 associates at least one reference color with at least one predefined color category.

Then, at step 130, color matching and/or color recommendation function of color system 20 is selected. In the illustrative embodiment, a user will have an option to specify whether color match or color recommendation is desired. The user may select either one of the two functions, or perhaps both of the functions (e.g., the user may desire to find a color match for one reference color, and then find color coordinate(s) for another reference color).

Alternatively or in addition to, color system 20 could also be configured to automatically select a given function based on a number of criteria, including a reference color and/or a type of item being searched for. To illustrate, consider a user who inputs (e.g., uploads) an image of a skin color.

If the user indicates that she is looking for powder and/or foundation, the color system could then automatically use color-matching section 50 to search for “best” matching, or closest, colors of foundations and/or powders. On the other hand, if the user submits an image of her skin color and indicates she is looking for an item of clothing or another type of product of potentially different color from the color(s) in the image, color system 20 could responsively invoke color-recommendation section 60. However, the user can always override any automatic functions of the system.

Then, at step 140, color system 20 identifies one or more matching and/or coordinating colors and/or items. In some embodiments, the color system could identify the one or more matching and/or coordinating colors and/or items based on the respective color category associated with the reference color. In this regard, color system 20 could, for example, use a corresponding color-category descriptor of the reference color as a basis (e.g., as a search query) for finding and recommending colored items associated with at least same color-category descriptor as the reference color.

Color Characteristics and Categorization

As noted above, in accordance with the illustrative embodiment, to facilitate finding matching or coordinating colors/items, colors are grouped into distinct categories based on a number of characteristics.

In accordance with the present embodiment, colors within visible spectrum may be categorized based at least on such characteristics as hue/temperature, value, and chroma. The characteristics of hue, value, and chroma are commonly known in the art as three dimensions of color. Note that, in other embodiments, color categories may be defined based on other characteristics that those described herein. Further, color categorization can be carried out in other ways as well.

Hue generally denotes what is visually thought of as “color,” such as red, green, or blue. Multiple colors may have the same hue value, or hue component, and thus may be generally be thought as belonging to the same “color family,” such as “reds”, “greens,” “blues,” etc. Note that, as used herein, the term “color family” will generally denote colors having either same hue value/component (e.g., 20% hue value) or colors within a given hue range (e.g., colors having hue values of 20%-40%, could be considered to be a part of the same color family, such as “reds”).

Colors of the same hue can be further distinguished by two other color dimensions which refer to their lightness and strength. Namely, the second dimension known as “value” denotes color lightness, and provides an indication of whether a given color is a light “hue” or a dark “hue.” Depending on a given color space (or model), “value” may instead be termed as “lightness,” such as in the HSL color model and CIELAB (or Lab) color model. Chroma is the third color dimension that generally defines color strength. For example, two colors can have the same hue and value, but one color can be “stronger” in color (i.e., brighter) than the other color. Those skilled in the art will be familiar with those color-related concepts.

Further, in the illustrative embodiment, colors are categorized on the basis of their color temperature. Typically, colors with higher temperatures are called “cool” colors (e.g., blueish white), while colors with lower color temperatures are called “warm” colors (e.g., yellowish white through red). Although a hue value of a color and color temperature are generally directly proportional, depending on the values of the other two dimensions (i.e., value and chroma), some colors having the same hue could be considered “warm” colors while others could be considered “cool” colors.

The concept of color temperature is particularly important in beauty and fashion applications. With correctly chosen colors, a person's skin, eyes, and hair may be positively emphasized. With incorrect color choices a person's natural features may get “lost.”

By way of example, when selecting a foundation, a person with a “warm” skin color may look better in color foundations with pink undertones. Similarly, a person with a “cool” skin tone may look better in foundations having “yellow” undertones.

In one embodiment, temperature of a color having a given hue can range between two endpoints of “warm” and “cool,” with a number of intermediaries in-between. In one practical example, color temperature can be described as being either: (1) warm, (2) warm-intermediate, (3) intermediate, (4) intermediate-cool, or (5) cool.

Color value can range from “dark” to “light,” with a number of intermediaries in-between. In one practical example, color value can be described as being either: (1) dark, (2) dark-medium, (3) medium, (4) medium-light, and (5) light. Similarly, color chroma can range between two endpoints of “bright” and “soft,” with a number of intermediaries in-between. In one practical example, color value can be described as being either: (1) bright, (2) bright-neutral, (3) neutral, (4) neutral-soft, and (5) soft.

Based on these descriptions, a color category may be described by a corresponding “color-category descriptor” (or “category descriptor,” for short), such as {Warm, Dark, Bright} or {Warm, Light, Soft}, that describes a combination of characteristics uniquely identifying the color category. For example, based on the above ranges of each of the color dimensions, it would be possible to define a number of unique/distinct color categories to essentially cover the entire color spectrum. Table 1 below shows one example of different ranges of each of hue/temperature, value, and chroma that could be used to define a number of unique color categories.

TABLE 1

| DIMENSIONS | CATEGORIZATIONS (RANGE DESCRIPTORS) | | | | |
|---|---|---|---|---|---|
| Hue/Temp | Warm (W) | Warm-Int (WI) | Intermediate | Int-Cool (IC) | Cool (C) |
| | | | (I) | | |
| Value | Dark (D) | Dark-Med | Medium (M) | Med-Light (ML) | Light (L) |
| | | (DM) | | | |
| Chroma | Bright (B) | Bright-Neu | Neutral (N) | Neu-Soft (NS) | Soft (S) |
| | | (BN) | | | |

Each color category can be described using any names for the purpose of database query and searching for instance. By way of example, as shown in Table 1, a given color may be assigned to color category “Warm 1”, where a corresponding category descriptor may be abbreviated as {W, D, B}. As shown above, different color categories may be defined across different combinations of ranges of hue/temperature, value, and chroma dimensions to cover all of the colors used for matching and coordination: {Warm, Dark, Bright}, {Warm, Light, Soft}, {Intermediate, Dark, Bright}, {Intermediate, Light, Soft}, {Cool, Dark, Bright}, {Cool, Light, Soft}, and so on.

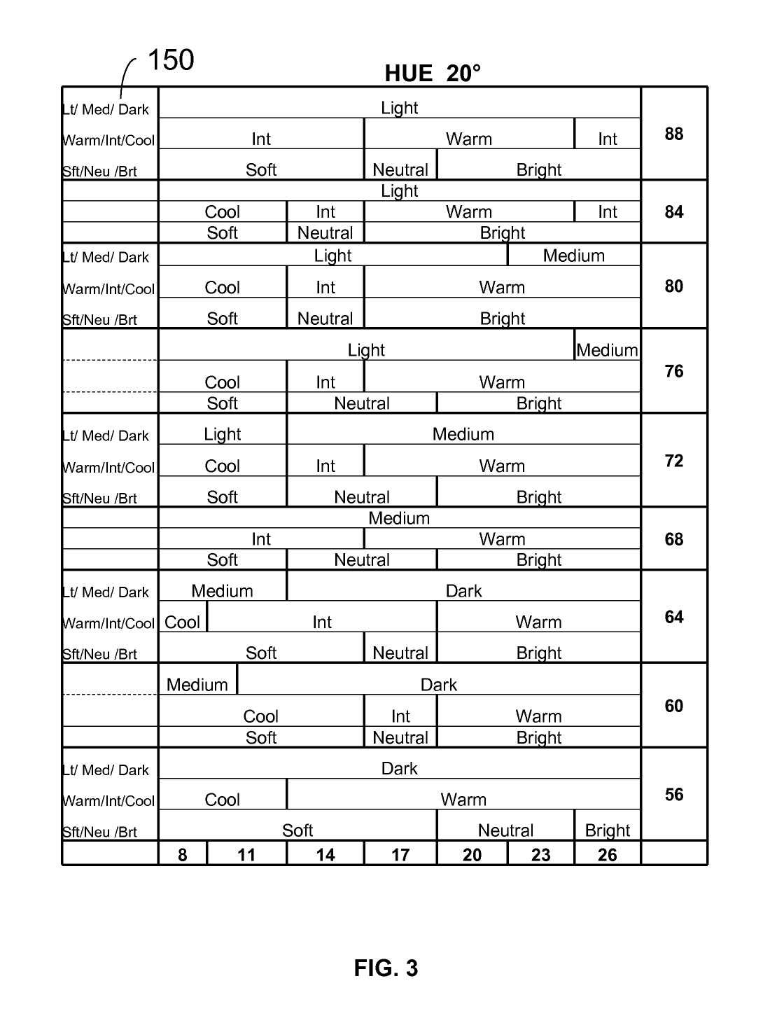

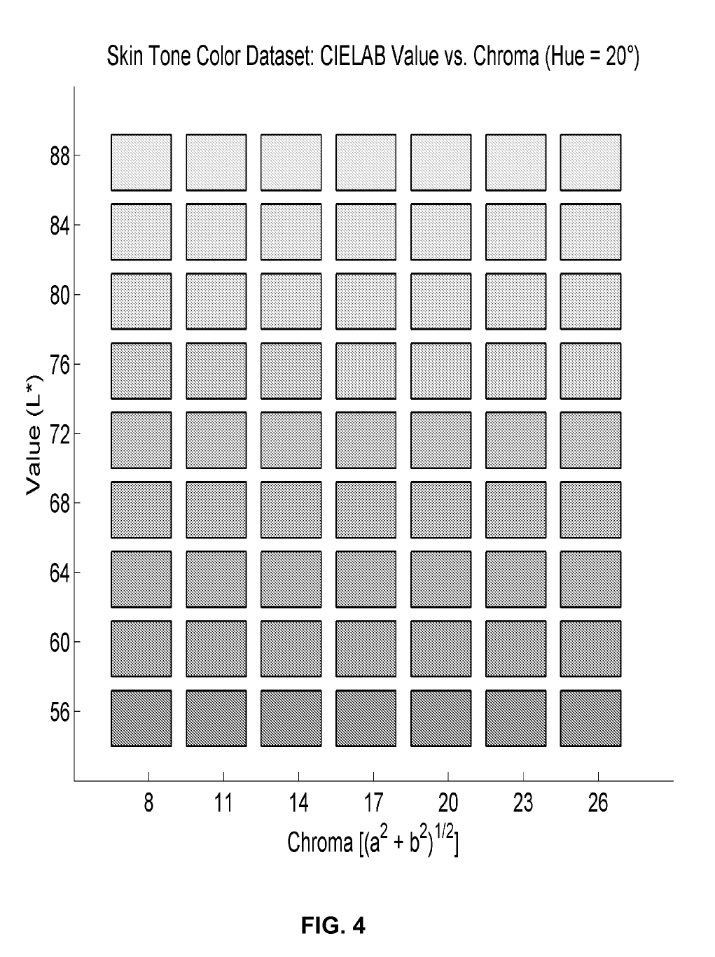

FIGS. 3 and 4 then illustrate one example of how colors could be categorized based on their values of hue, value, and chroma. FIG. 3 illustrates a family of skin colors (or “skintone” colors as shown) that were characterized as having a hue of 20 degrees. In this example, the hue, value (or “lightness”), and chroma values for colors in FIG. 3 were measured/computed based on the CIELAB color model, which is considered an absolute color space and generally viewed as more perceptionally uniform color space than other color spaces. Further, CIELAB color space is based on the three dimensions of hue, value, and chroma. Although not shown, CIELAB parameters of a given color could be conveniently converted to a number of different color spaces, such as an XYZ, HLS, and/or other(s).

FIG. 4 then shows a corresponding color-categorization chart for this color family. As shown in the FIG. 4, the x-axis corresponds to chroma values, which in this case, range from 0-26. The y-axis corresponds to value (or lightness) values, which in this case, range from 0-88. Column 150 denotes labels for different ranges of each of color temperature, value, and chroma. As shown in FIG. 4, colors with hue of 20 degrees and having chroma values in the range of 0<C<11, and “lightness” values in the range of 0<V<56 can be assigned to a category of {Cool, Dark, Soft}. Then colors of the same hue but having chroma values in the range of 20<C<23, and “lightness” values in the range of 56<L<60 can be assigned to a category of {Warm, Dark, Neutral}.

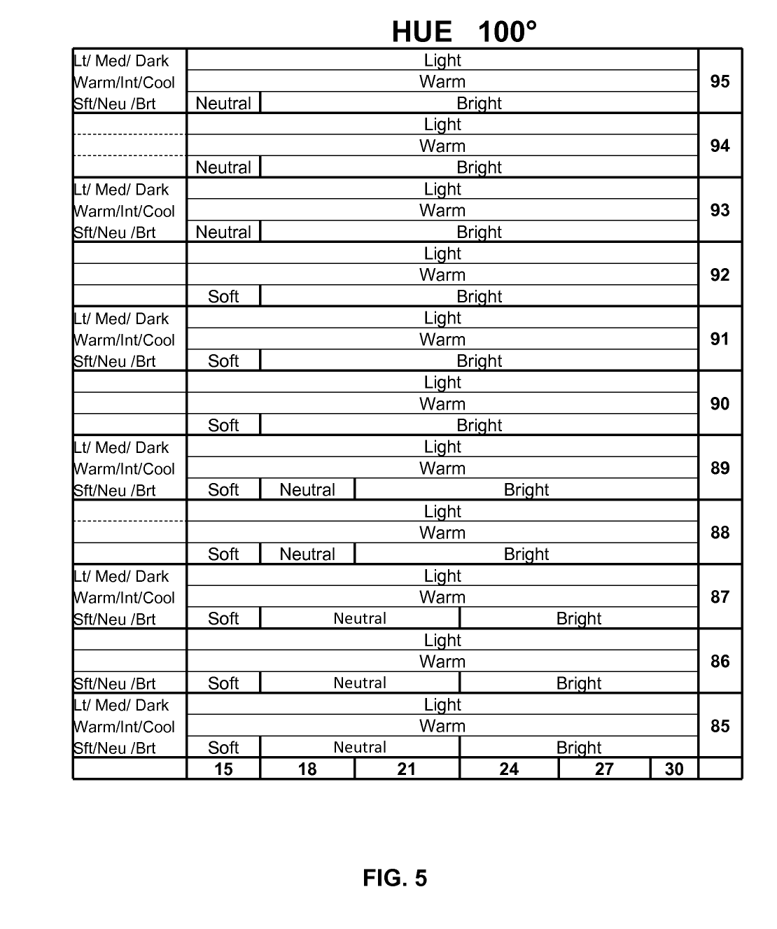

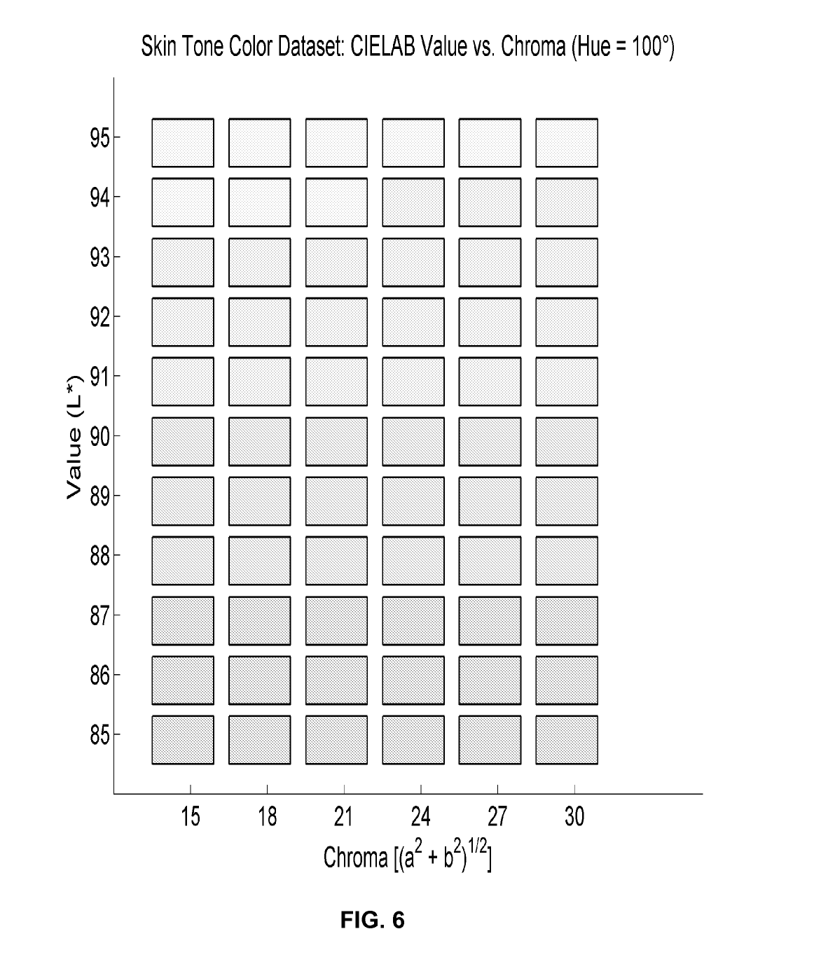

FIGS. 5-6 then illustrate similar examples of color categorization for a skin color family with a hue characteristic of 100 degrees. In the present embodiment, color categorization may be carried out based on an input from a color/image consultant, color scientist, predefined color charts and/or other means available in the color industry. In this regard, for example, color temperature may be measured with an actual color-measuring device and/or software, and colors could be the divided into appropriate ranges based on their actual temperatures. Those skilled in the art will recognize that various ways of defining suitable ranges for each of the category characteristic may be possible.

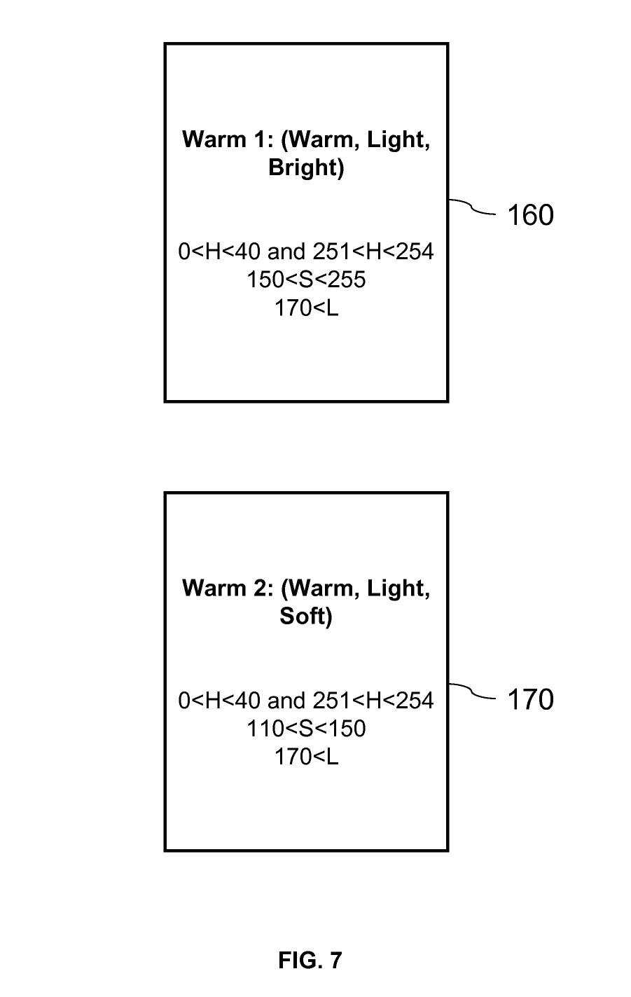

Further, in the illustrative embodiment, colors of different hues across an entire visible spectrum can be similarly categorized as in the examples above. FIG. 7 depicts an example of two color categories and corresponding colors that fall into those color categories. As shown in FIG. 7, each color category corresponds to a respective group of different colors having hue, value (or lightness), and chroma values within specific ranges. In the example of FIG. 7, values of hue, value, and chroma have been expressed using HLS parameters represented as a linear translation of RGB (i.e., HSL parameters multiplied by a factor of 255). Further, in this example, the HSL paremeters were derived from corresponding CIELAB parameters, but in other examples, those values could be defined using any other parameters. (Note that, in an HLS color model, value (lightness) and chroma are defined in terms of saturation (S) which is a ratio of lightness and chroma).

As shown in FIG. 7, a first color category 160 with a descriptor of {Warm, Light, Bright} corresponds to colors with hue values ranging between 0<H<40 and 251<H<254, lightness values of L>170, and saturation values ranging between 150<S<255. Then, a second color category 170 with a descriptor of {Warm, Light, Soft} corresponds to colors with hue values ranging between 0<H<40 and 251<H<254, lightness values of L>170, and saturation values ranging between 110<S<150.

Note that some colors may have hue, value, and/or chroma values that may fall “in-between” different color categories. However, in preferred embodiments, color categorization will be such that each color is associated with one distinct color category.

As noted above, in the illustrative embodiment, color system 20 will preferably operate to associate a reference color with one respective color category. For example, referring back to FIG. 7, based on hue, lightness, and chroma values of a given reference color, say (20, 252, 151), the system may determine that the reference color falls into a category “Warm1” having a corresponding color-descriptor of {Warm, Light, Bright}. Thus, the reference color will be associated with the color category corresponding to a group of colors that have been characterized as being warm, light, and bright. Accordingly, the system may then use the color-category descriptor of the reference color as a basis for finding matching and/or coordinating items.

Color-Dominance Determination

In a default operation, when a color input contains multiple colors, such as a digital image, at step 110, the system may be configured to determine which color is to be used as a reference color for color matching and/or color recommendation. In one embodiment, this determination could be made based on dominance of a given color in the color input. Further, the dominance of the given color could be based on a number factors, such as a (1) dominant presence of the given color and (2) color “intensity” of the given color.

Dominant color presence may be determined based, for example, on a respective surface area of a color in the input object, such as a digital image. In general, dominant presence of a given color would be directly proportional to the surface area of that color in the object, i.e., the greater the surface area coverage of the color in the reference, the higher the dominance value of that color.

Note, however, that the system could have the ability to select more than one color to be “dominant” colors (such as, for example, when two or more colors appear to be equally dominant or based on user selection) and provide color matches and/or coordinates for each of the “dominant” colors separately or based on a combination of those dominant colors. Also, the user may have the ability to override any system functionality and select any desired combination of reference color(s).

In practice, surface area “measurement” could be carried out by pixelating an image or a given region of the image (e.g., a region selected by a user), and reading color data associated with each pixel data, such as RGB or HLS parameters (or any other color space parameters) associated with the pixel by measuring each pixel separately. In particular, color represented by the largest number of pixels, and thus highest surface area, would be assigned the highest dominance (value), while the color represented by the lowest number of pixels would be assigned the lowest dominance (value). For sake of example, assume that a reference object contains N number of colors. The most dominant color in the reference object could be ranked highest on the dominance scale with a value of N, while the least dominant color could be ranked lowest on the dominance scale with a value of 1. (Note the system could be configured to detect background color(s) and disregard those when making color-dominance determination-using any now available (e.g., proprietary) or later developed algorithm(s).

By way of example, a color input could be a digital image of a person's face showing the person's skin color, eye color, lip color, and hair color. In this regard, color system could be configured to detect that the presence of facial features in the digital image input and extract the person's skin color, eye color, lip color, and hair color accordingly. In this regard, the color system could use a suitable face-recognition algorithm.

Based on surface-area measurement, the system could then determine that a skin color has the most presence in the image, or is the dominant color. As another example, a color input could be a digital image of a fabric containing multiple colors, e.g., red and green. Based on the surface-area measurement, the system could then determine that the “red” has the most presence in the image, or is the dominant color.

If the user is looking for a matching foundation, then the skin color would normally be the most important search criteria for finding closely matching foundation. However, in other examples, the color that is determined to be “dominant” based on surface-area may not be desired as the primary criteria for identifying color matches or color coordinates/recommendations. In the above example, suppose that the user is instead looking for a complementing eye shadow. Although the user's skin color may be still of concern, the eye color would likely be the primary criteria in making the final shadow selection.

According to one embodiment, the system may assign color weights to the colors in the input object. Further, the system could function to allow a user to specify/modify weights to the colors in the reference object. As an example, if the primary colors present in reference object are skin color, eye color, lip color, and hair color and the user is looking for a matching foundation, then skin color could be weighted more heavily than other colors. By default, multiple colors in the reference could be assigned equal weight (e.g., 1/N, where N is a number of colors in the reference). However, based on a given application, product being searched for and/or user specification, the weights assigned to respective colors could be modified accordingly either by color system 20 or a user.

To illustrate, in the above example, the user could indicate that the user wishes to find a matching foundation. If the user provides a face image, skin color would normally cover the greatest surface area, and thus have the dominant presence. Instead or in addition to, the system could automatically assign most weight to skin color, while other colors extracted from or detected in the reference image could be each assigned smaller respective weights. On the other hand, if the product being searched for is an eye shadow, the system could automatically detect the user's product selection and assign the highest weight to the eye color to set the eye color as the dominant color.

Another factor contemplated in this embodiment is an “intensity” of color appearance to a human eye. More specifically, based on human perception, some colors may appear more “striking” than others. Advantageously, in the illustrative embodiment, this phenomenon may be used to determine which color or colors in the color input tend to be more dominant than others. More specifically, color dominance would be directly proportional to color “intensity.”

To illustrate, humans may perceive certain colors as more “striking” or “intense” than others. With respect to a color temperature for instance, an orange-red may appear to a human eye as being “more intense” than a simple red. Thus, as the color gets warmer (e.g., towards the “red” family), the more “striking” it will appear. Similarly, as a color gets cooler (e.g., towards the “blue” family), the more “striking” it will appear. With respect to a color value, the lighter and darker the color, the more “striking” it will appear (e.g., white and black would appear more “striking” than grey). Then, with respect color chroma, the brighter the color is, the more “vivid” it will appear.

Thus, when looking at an object, such as a piece of clothing containing multiple colors, some color(s) may “stand out” more than others. Thus, it may be desirable to find color coordinates for the most “striking” color(s) in the input object. Makeup-related applications are another example where color “intensity” may be important.

Consider a user looking for a blush to coordinate well with the user's lipstick. The user may upload an image showing the user wearing the lipstick. Although typically a skin color will still be an important criteria in make-up related matching or coordinating applications, the user's lip color may be the most “intense” color in the image. As such, it may be desirable to assign a higher weight to the user's lip color to ensure that the blush and the lipstick do not “clash.” For example, based on skin color alone, a pinkish blush may be suitable for the user. However, with a given colored lipstick, another blush having more of a rosy hue may be more appropriate. Various other examples may be possible as well.

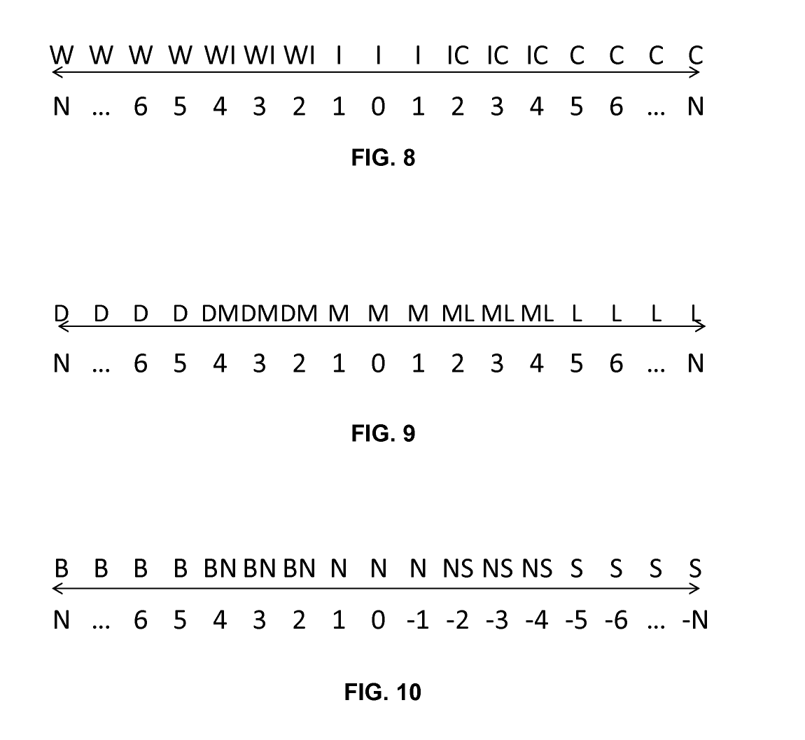

In one embodiment, each color in a given category may be further described by a “degree” or “level” of each color characteristic. FIGS. 8-10 illustrate in more detail, how each of color-category characteristics could be divided into a number of levels ranging from 0 to N and 0 to −N, where N refers to the highest level, to indicate color “strength” or “vividness” of colors having a given color characteristic.

In this regard, FIG. 8 depicts a color temperature scale and the associated level values, FIG. 9 depicts a value scale and the associated level values, and FIG. 10 depicts a chroma scale and the associated level values. Note that N could be set arbitrarily based, e.g., on desired amount of granularity and can take on different values.

Table 2 below is a modified version of Table 1, showing each color-category characteristic and its associated level values. In this particular example, N has been set to an arbitrary value of 7, but in other examples, it could be a different value.

TABLE 2

| Dimensions | Categorizations (Range Descriptors) | | | | |
|---|---|---|---|---|---|
| Hue/Temp | Warm (W) | Warm-Int (WI) | Intermediate (I) | Int-Cool (IC) | Cool (C) |
| Levels | 7, 6, 5 | 4, 3, 2 | 1, 0, 1 | 2, 3, 4 | 5, 6, 7 |
| Value | Dark (D) | Dark-Med | Medium (M) | Med-Light (ML) | Light (L) |
| | | (DM) | | | |
| Levels | 7, 6, 5 | 4, 3, 2 | 1, 0, 1 | 2, 3, 4 | 5, 6, 7 |
| Chroma | Bright (B) | Bright-Neu | Neutral (N) | Neu-Soft (NS) | Soft (S) |
| | | (BN) | | | |
| Levels | 7, 6, 5 | 4, 3, 2 | 1, 0, −1 | −(2, 3, 4) | −(5, 6, 7) |

Based on the above, a given color could be then described in terms of its: (i) color data, such as selected color-space parameters (e.g., CIELAB parameters (88, 7.5, 2.7), XYZ parameters (72, 72, 75, etc.) or some other parameters denoting hue (H), value (V), and chroma (C) (e.g., HVC=(20, 88, 8)), (ii) a first color-category descriptor (which, by way of example, could be termed “Level I descriptor”), such as {Intermediate, Light and Bright} and/or the like, and (iii) a second color-category descriptor (which, by way of example, could be termed “Level II descriptor”), such as “I-0, L-7, B-5” and/or the like, where example values of 0, 7, and 5 correspond to particular level values of color temperature, lightness, and chroma, as shown in FIGS. 8-10 and Table 2 for example.

Note that although the present embodiment contemplates the use of Level II descriptors with respect to dominant-color processing, it may be also possible to use this type of “finer” or more granular categorization for other functions, such as finding color matches and/or color coordinates.

The dominance processing could then function based on a rule that a higher combination of hue, value and chroma Level II values, the higher the dominance. The warmer or cooler the color, (1) the higher the Level II Category Descriptor, and the higher dominance, (ii) the lighter or darker the color, the higher the Level II Category Descriptor, and the higher dominance, (iii) the brighter the color, the higher the Level 2 Range Descriptor, and the higher dominance. Further, respective weights may be assigned to each of the Level II color-category characteristics. By default, each Level II color-category characteristic could be assigned equal weight (e.g., 1/N, where N is a number of color category characteristics). However, based on a given application, product being searched for and/or user specification, the weights assigned to respective colors could be modified accordingly either by color system 20 or a user.

Thus, the dominance-determination section of system 20 could function to determine which of the multiple reference colors is a dominant color to be used as a basis for color matching and/or color recommendation. As noted above, the dominance-determination section of system 20 could carry out this function based on respective weights assigned to multiple reference colors and a number of dominance factors, such as a color presence and color “vividness,” or “intensity.” In a further embodiment, each of the color-dominance factors could also be weighted respectively.

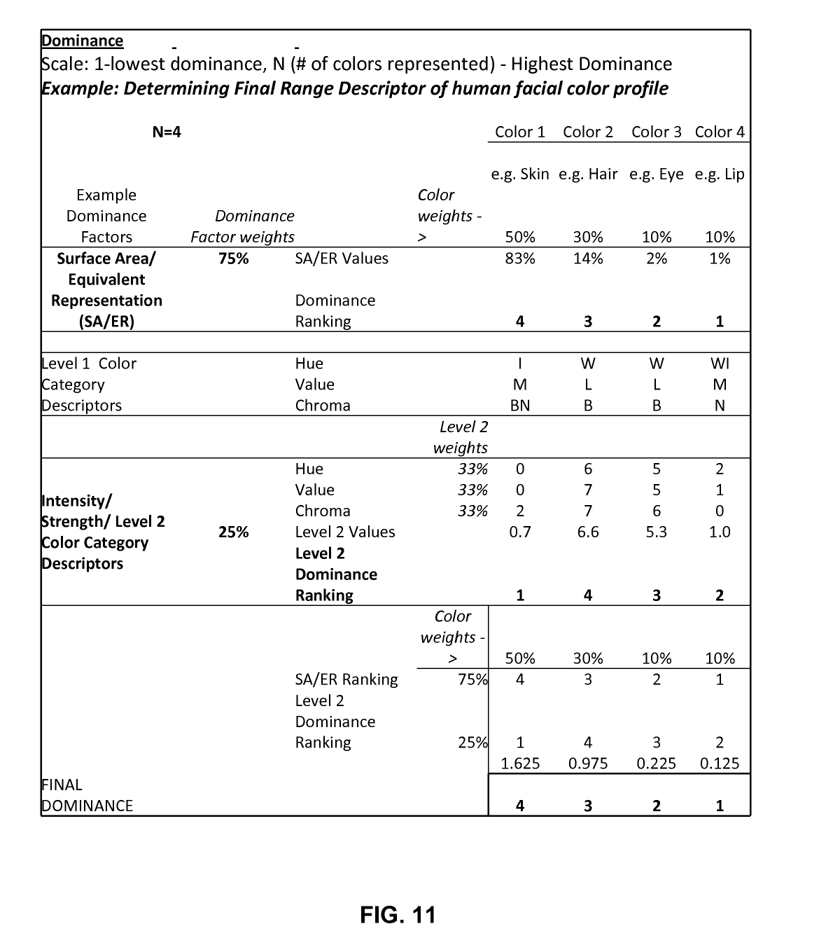

Further, a dominant color determination could be based on any combination of the above-described dominance determining-functions. By way of example, FIG. 11 depicts one example application of the dominance system functionality. In FIG. 11, for example, Color 1 (e.g., a skin color) would be selected as the dominant reference color and serve as a basis for finding matching and/or coordinating items. In particular, color-dominance determination could be carried out based on two factors, such as a surface area and color “intensity.”

As shown in FIG. 11, respective weights could be assigned to each of those factors. For example, surface-area factor could be assigned a weight of 75%, while color “intensity” could be assigned 25%. Similarly, respective weights could be assigned to each of colors 1-4. In the example of FIG. 11, color 1 (e.g., a skin color) has been assigned a highest weight of 50%. Each of the color-category characteristics has been assigned an equal weight of 33%. Further, “Level II values” have been calculated as a sum of individual hue, value and chroma level values.

In this example, based on a surface area, color 1 has been ranked highest. Based on color “intensity,” color 2 (e.g., hair color) has been ranked highest. After applying respective weights to each of the factors, colors 1-4, and Level II values, the final dominance calculation results in color 1 being ranked the highest, and such, being the dominant color. Color 1 may be then used by color system 20 as a reference color for finding color matches and color coordinates.

Color and Product Database(s)

In the illustrative embodiment, color system 20 may use one ore more reference colors as a basis to find matching and coordinating items for a user. In this regard, color system 20 may include one or more database(s) (or other type of data storage) holding data representative of different colors and items (or products) for the purpose of color matching and recommendation.

As noted above, one of the benefits of the present system is the ability to find matching or coordinating make-up and fashion products. In this regard, the present embodiment recognizes that a person's skin tone will often be a significant factor in selecting appropriate colors for the person. Advantageously, in the illustrative embodiment, color system 20 will be configured to include or have access to a database of various possible human skin colors.

In one practical implementation, it was possible to build a database of approximately 2,000 skin tones by measuring skin colors of actual human subjects using spectrophotometer, extracting colors from digital image of human faces, and extracting skin colors from skin-tone charts. By having determined the “extremes” of possible skin colors and a number of in-between colors, further regression analysis was applied to derive additional skin colors (using CIELAB for example) to essentially cover almost any skin color that could be input to the system. Each of the skin colors was characterized based on its hue, value, and chrome characteristics, and categorized accordingly.

Further, a database of foundation colors associated with almost 9,000 different foundation products across a variety of brands was established. In one example, color information was obtained from digital swatches of foundation colors. In alternative examples, color information (e.g., color data) could be directly obtained from manufacturers and/or retailers. In yet another example, it may be possible to derive color data directly from the product (e.g., by color analysis of the actual product itself).

In one embodiment, color system 20 could be configured to build up a color database by identifying color(s) in product images and extracting those color(s). The system may then automatically add the extracted color(s) to the color database. As an example, given a digital image of a fabric (e.g., a fabric swatch of a dress), the system could first color-correct the image (as described above), pixelate the image, and then determine/compute color data for every pixel. Alternatively, the system could first color correct the image, select portion(s) of the image representing one or multiple pixels or predefined “squares” or pixel “clusters” and compute average color data for the selected portion(s). Any available algorithm now available or later developed could be used to perform the above-noted color measurements. Preferably, the system will operate using an absolute color space, such as CIELAB, to better capture perceptional uniformity of a color.

The system could then automatically add the identified/extracted color(s) to its color database. Additionally, the system may allow third party users (e.g., manufacturers or retailers) to update the database and enter color information using any desired format. The retailers or other users could have an ability to assign either “universal” colors to all applicable products or define and store new colors (e.g., define and store new foundation colors outside of an industry-used “universal” shades). Color information in the database could be converted to all major color-space parameters to enable color referencing across different users, regardless of a color model/space used at their end.

Note that items held in the database could be associated with one or more colors. If an item contains a single color, then the item would be associated with one color. However, some items will contain multiple colors, and as such, could be associated with multiple colors. In this regard, third-party users, such as retailers, could have an ability to enter/assign multiple colors to one product (e.g., an eye shadow set containing multiple colors). Alternatively, for multiple-colored items, color system 20 could instead determine dominant color present in the item (e.g., based on surface area of colors in the item), as described in detail above. Additionally, the system could be configured to automatically index and store a product image, such as for later presentation to a user.

By way of example, each product stored in a database could be associated with a number of attributes, including product type, name, color data, product style, etc. In addition, in one embodiment, each product could be conveniently associated with one or more color categories corresponding to respective colors in the product. (Colors of the products would be then categorized the same way as colors input by a user.) Table 3 below provides one example of a number of product attributes in a database.

TABLE 3

| | | | COLOR | |
|---|---|---|---|---|
| PRODUCT KIND | NAME | COLOR DATA | CATEGORY | STYLE/LOOK |
| LIPSTICK | BRAND A #25 | (H, V, C) (e.g., | W (E.G., WARM | DAY LOOK |
| | | CIELAB data, | 1) | |
| | | HLS data, etc.) | | |
| DRESS | BRAND B | (H, V, C) | C (E.G., COOL | CLASSIC |
| | | | 2) | |
| . . . | . . . | . . . | . . . | . . . |

Color Matching and Color Recommendation

a. Color Matching Functionality

As noted above, in the illustrative embodiment, color system 20 may provide both color matching and color recommendation functionality. As defined above, a “matching color” generally denotes any color that could be the same as a reference color or substantially close to the reference color, such as a color having color data within a certain tolerance range (e.g., within 0%-20% tolerance from color data of a reference color).

Particularly, in accordance with one embodiment, color-matching section 50 of color system 20 can identify matching color(s) and/or item(s) associated with the matching color(s). In this regard, color system 20 could function to (i) receive a color input indicative of one or more colors, (ii) select at least one reference color from the one or more colors, and (iii) compare the at least one reference color to a plurality of predetermined colors to identify one or more colors having color data closest to the at least one reference color.

Color system 20 may provide a user with several options of finding “best” matching colors and/or products. By default, the system may first attempt to find a product that is an exact color match to a reference color. In one example, the color system may compare the reference color to predetermined colors (e.g., color data corresponding to different colors and stored in a suitable data storage, such as a database) in an attempt to find an exact color match. In this regard, the system may perform a database lookup using the reference color as a database query to find a color and/or matching product having the same color data (e.g., same color parameters (e.g., (x, y, z)) as the reference color.

In another example, color system 20 could compare a reference color to predetermined colors by calculating color-data differences between the reference color and predetermined colors to identify one or more colors having color data closest to the reference color. Color system 20 could, for example, automatically calculate (or compute) differences between reference color data and other color data defined by, stored by, and/or accessible to the system (e.g., color data corresponding to different colors and pre-stored in the system's database or another data storage). Those skilled in the art will be familiar with different ways of computing a difference between two colors.

As one example, the system could compute absolute differences between individual color parameters (e.g., x1, x2, x3) and (xref, yref, zref) of the reference color and another color, such as |xref−x1] and so on, and could then sum up those differences to arrive at a single differential Δ.

In this regard, the system may first convert reference color parameters into another suitable color-model parameters (e.g., CIELAB or another pre-defined parameters that are more indicative of individual values of hue, value (or lightness), and chroma).

As a result of this computation, one or more colors having the closest color data to the reference color could be identified. In this regard, for example, the system may consider only those colors having color data within a certain tolerance range, such as within 0-20% tolerance range. The tolerance value(s) may be determined based on the calculated color-data differences between individual color parameters (e.g., (x1, x2, x3) and (xref, yref, zref)) of the reference color and another color or based on a single differential.

This tolerance range may be set arbitrarily and may vary, for example, according to a product type and/or a particular type of color data parameters. By way of example, acceptable tolerance range for what is considered a matching foundation or powder could be 0-5%, while for other products it could be greater, such as less than 10%. By default, the tolerance range could be set to 0-20%. As noted above, color system 20 could also be configured to consider a type of color data parameters. As an example, a 5% deviation from XYZ color parameters of a reference color could yield a different color than 5% deviation from Cielab color parameters of the reference color.

Further, the colors with the closest color data to the reference color may be, for example, sorted according to the lowest color data difference and returned to a user. The user may have an option to further narrow down the search results by specifying additional criteria, such as an option to return only those colors from the set of colors with the closest data that belong to the same color family and/or same color category. In this regard, the system could read, for example, respective hue values and color-category descriptors associated with the reference color and colors having the closest color data.

It is also possible that computed differentials between the reference color and one or more predetermined colors may be the same or substantially close. As in the above example, in such case, only those colors from the set of colors with the closest data that belong to the same color family and/or the same color category may be returned to the user. The system, however, can be alternately configured to allow the user to set color-matching priorities. In one example, the user (e.g., a graphic/web designer) may not be interested in finding an exact color match but would rather prefer to find one or more closely matching colors within same color family. As such, the user could set “Hue” as the highest level of priority for color matching. In another example, the user could set the “Category” as the highest level of priority if the user prefers to find one or more similar colors falling into the same category as the reference color. In yet another example, the user may specify any given combination, or order, of priorities the system is to follow when attempting to find matching colors.

Also, if a user is looking for certain products, such as powders or paint colors, a user may desire to find closely matching product(s) that may be one or more shades lighter than a reference color (e.g., a skin color). In this regard, color system 20 could be configured to allow the user to specify such preference. In turn, color system 20 could then select and return only those colors having closest color data within a given color family and meeting a desired lightness criteria.

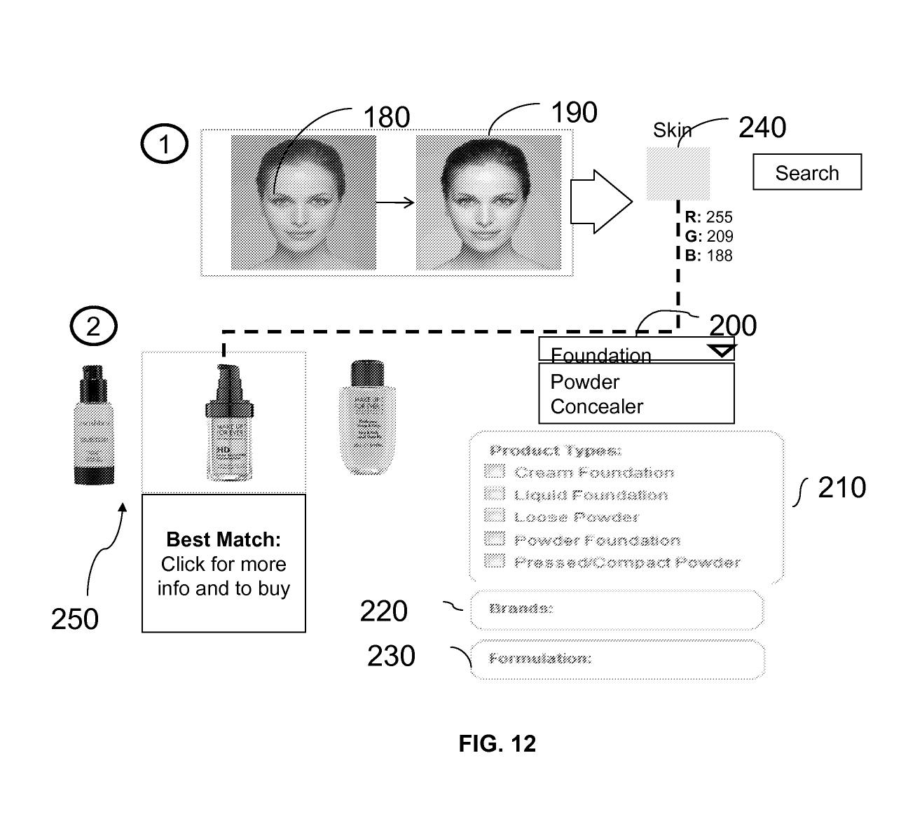

FIG. 12 shows one example to illustrate how matching section of color system 20 could function in practice. As shown, a user could upload a digital image 180 of her (or another person's) face. The image could be color-corrected as described above to render a second color-corrected image 190. Further, a user may select a kind of product (item 200) being searched for. In this case, the user could select foundation as the desired item. Additionally, in the illustrative embodiment, the user could further specify additional criteria to narrow down the search, such as product type (item 210), a particular brand (item 220), formulation (item 230), etc.

As described above, the system may automatically extract skin color from the image (e.g., as a dominant color), and may further display a sample image 240 of the extracted skin color for the user. Further, based on the selected kind of product for example, the system may automatically select color-matching functionality.

In this regard, the system could identify colors closest to the reference skin color of the person in the input image, and return foundation products 250 associated with those colors. In this regard, the system may be able to find foundation colors that have color data substantially the same as the person's skin color. If the system cannot find “exact” color matches, the system could then consider the foundation product having colors within the same color family as the reference color.

Advantageously, in the illustrative embodiment, the system could then select only those foundations colors within that color family that have been categorized as having at least the same color temperature characteristic (e.g., warm or cool) as the reference color and/or the same chroma. Other ways of identifying matching products may be possible as well.

In addition, in one embodiment, color system 20 may have the capability to “web-crawl” for products if the system cannot find any coordinating item(s) in the local system database.

b. Color Recommendation Functionality

As a general matter, to find coordinating color(s) and/or item(s), color-recommendation section 60 of color system 20 functions to identify color(s) within same or similar color categorie(s) or different color categorie(s) as the reference color.

In a default operation, the color-recommendation section of color system 20 may first attempt to find color(s) belonging to the same category as the reference color. For example, the reference color may be associated with a color category having a corresponding color-category descriptor of {Warm, Light, Bright}. As such, the system may first consider colors that belong to the same category as the reference color as the basis for finding coordinating items. In this regard, color system 20 could use the color-category descriptor of the reference color as a basis (e.g., as a search query) for finding and recommending colored items associated with at least the same color-category descriptor as the reference color.

If no color falls within the same category as the reference color, such as no color has the same hue, value, and chroma characteristics (e.g., warm (hue/temperature-based characteristic)), light (value-based characteristic), and bright (chroma-based characteristic), the system may then proceed to look for related colors that have at least two or one of the same color-category characteristics as the reference color (e.g., same color temperature characteristic and/or same value or chroma characteristic). As an example, color system 20 may find other warm and/or light colors if the system cannot find any other “bright” color(s) having the same hue and value characteristic. Also, color system 20 may give a user an option to narrow down search results by color family, such as identifying only those colors/items within one or more color categories that belong to the same color family as the reference color.

Further, color system 20 may consider color categories different from that associated with the reference color to identify coordinating colors and/or items. Suppose a user is looking for a colored scarf to coordinate with the user's purple blouse. As such, the user may desire to create a color contrast between the scarf and the blouse. Accordingly, color system 20 could be configured to consider those color categories that contain colors having hue opposite to that of reference colors (such colors are commonly referred to in the art as “complementary”). In this instance, “yellows” could be appropriate to create a desired color contrast.

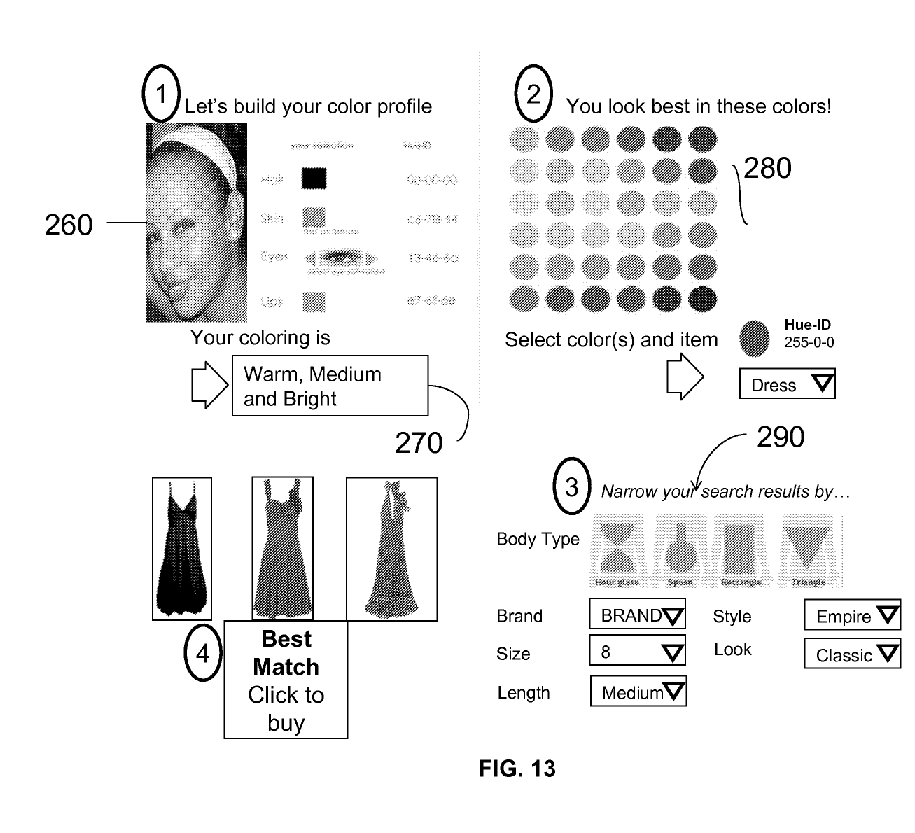

FIG. 13 shows one example to illustrate how color-recommendation section 60 of color system 20 could function in practice. As shown, a user could upload a digital image 260 of her face. Color system 20 could extract color information from the image, such as, for example, a skin color and/or other colors (e.g., lip color, eye color, etc., and/or the user could provide/select some of the colors directly (e.g., select hair color, eye color, etc.) from pull-down menus and/or pre-defined colors that could be further adjusted by the user (e.g., an eye color as shown in the FIG. 13). This color information could then be used (and potentially stored for later use) to define a unique color profile for a given person (e.g., the user).

Further, the system could then determine a color category 270 corresponding to the reference color(s), such as based on skin color. The system could then identify and display recommended colors 280 for the user. As described above, those colors could be colors associated with the same color category as the reference color (in this case, the category having a corresponding descriptor of {Warm, Light, Bright}). The user may then have an option to select one or more colors from the recommended colors.

Additionally, in the illustrative embodiment, the user could further specify additional criteria 290 to narrow down the search by specifying body type, brand, style, look, etc. The system could then return recommended products meeting the color and/or user-specified criteria. In fashion applications, for example, if the user specifies a given look (e.g., “classic,” “casual”, etc.), the system could further tailor the recommended color(s) accordingly. For example, if the user is looking for “classic” look, the system could automatically eliminate the colors/items that have too much sparkle. Those could be, for example, colors having chroma values above certain threshold value. Variations are possible.

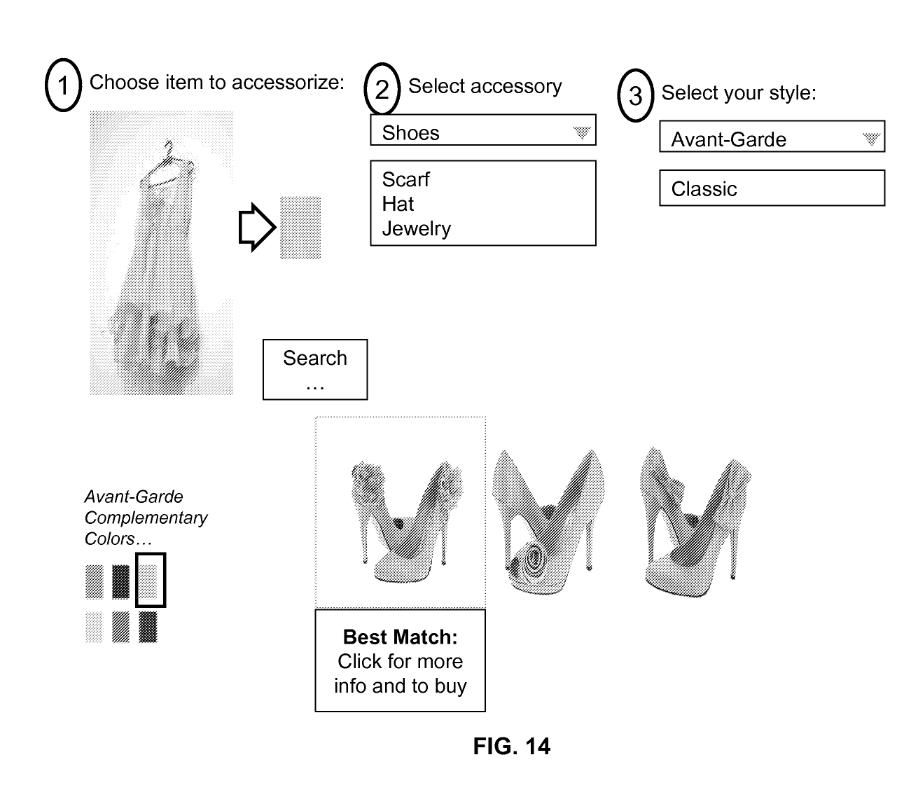

FIG. 14 illustrates another example of how color-recommendation section 60 could function in practice, such as to allow a user to find colored shoes, for example, to coordinate with the user's dress. In this example, the user may desire to create a color contrast between the dress and the and the shoes, and the system could find shoes of a given style (e.g., avant-garde) in complementary colors (e.g., dress could be orange and the shoes could be lavender).

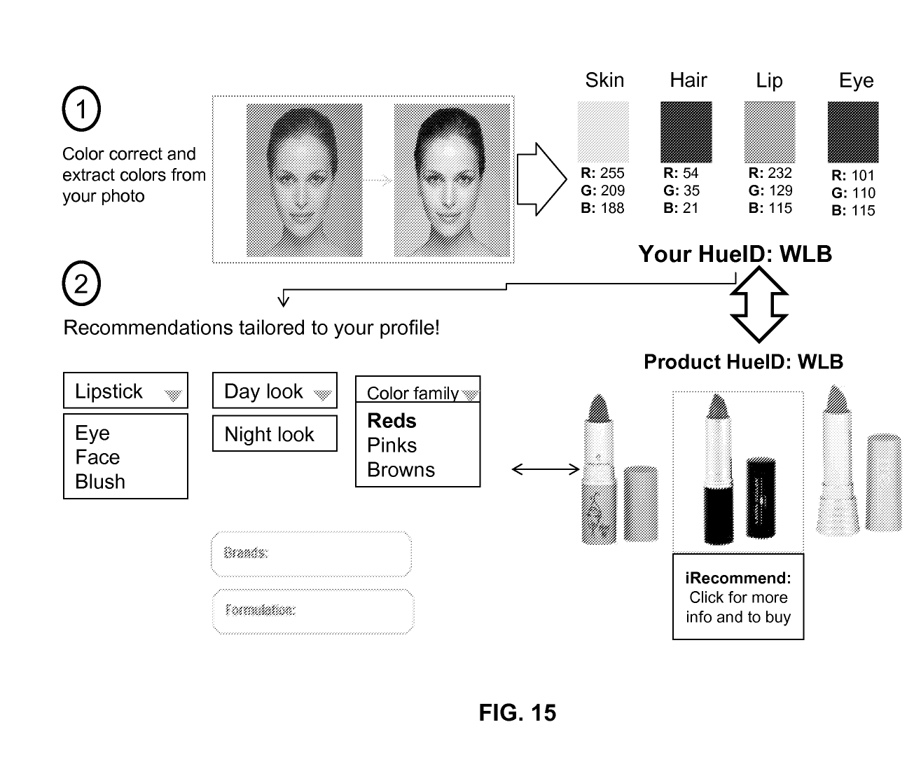

FIG. 15 then shows another example to illustrate how color-recommendation section 60 of color system 20 could function in practice with respect to cosmetic products, such as a lipstick for example. In this example, color system 20 could automatically extract color information from an image uploaded by a user, such as a skin color and/or other colors (e.g., a hair color, lip color, and an eye color). A user could further specify additional criteria to narrow down the search, such as a particular brand, formulation, look, color family, etc.

In this example, to find a coordinating lipstick, color system 20 could first associate reference color(s) with respective color categorie(s). The reference color could be, for example, a skin color that could be determined to be a dominant color). Coordinating lipstick color could then be a color associated with the same color category as the reference color (in this case, the category having a corresponding descriptor of {Warm, Light, Bright}).

The color system could also use a combination of reference colors, such as skin, hair, lip, and eye color to find a coordinating item, which in this example is a lipstick. In one particular example, color system 20 may be further configured to consider, for example, a combination of color categories/color-category characteristics from different color categories to identify a coordinating color and/or item. As such, color system 20 could associate each of a hair color, lip color, and an eye color with a respective color category. The color system could then use a combination of color categories and/or color-category characteristics from different color categories (that could be determined, e.g., based on respective color-category and range descriptors) to identify at least one coordinating color and/or item associated with that color.

One example of program logic for recommending a lip color, for example, could be as follows:

(1) If Skin Temperature=Warm and Hair Temperature=Warm, and

(2) If Skin Value=Dark and Hair Value=Dark or Light, and

(3) If Skin Chroma=Soft and Hair Chroma=Soft or Bright

THEN Lip Product Category=WDS

(4) If Lip Value=X, Lip Product Value=[X+/−(0% to 50%)X]

OR LipValue Range Descriptor must be >LipValue Range

In addition, in one embodiment, color system 20 may have capability to “web-crawl” for products if the system cannot find any coordinating item(s) in the local system database.

c. Multiple Color Input

As noted above, with reference to FIG. 2, color system 20 may also have the ability to consider two or multiple color inputs together as a basis for finding matching or coordinating colors/items for the user. By way of example, such functionality could be particularly useful when a user is trying to find coordinating products (e.g., accessories) for differently colored pieces of clothing or in home decoration applications for individual users or interior designers, for instance.

In one example, it is not uncommon for people to have various (e.g., contrasting or “mismatched”) furniture color combinations. A sofa can be of one color while a chair can be of some totally different color. Without coordinating items, such as a rug, color paint, and/or accessories (e.g., pillows for the sofa), the particular color combination may not be visually pleasing. But if such other items, such as proper wall paint color, rug, and/or other accessories, are incorporated, the whole look can work together fairly well.

In the above application, the user (e.g., an interior designer) could have an option to search using a combination of two reference colors to find coordinating items (e.g., paint color, pillows, etc.). In this regard, the system could be configured to provide a user with a single set of coordinating colors that could work for the combination of the multiple reference colors.

In one possible implementation, the system could first identify a set of coordinating colors for each of the multiple colors and could then identify any common colors between the two sets of colors, such as any color(s) from each of the two sets that have been assigned to the same color category). The system could then identify products having colors associated with that color category, and return those products to the user. If this operation yields no results, the system could then attempt to identify any common color(s) across any of the two category characteristics (e.g., value characteristic (e.g., “Light”) and chroma characteristic (e.g., Bright)).

Color System Architecture

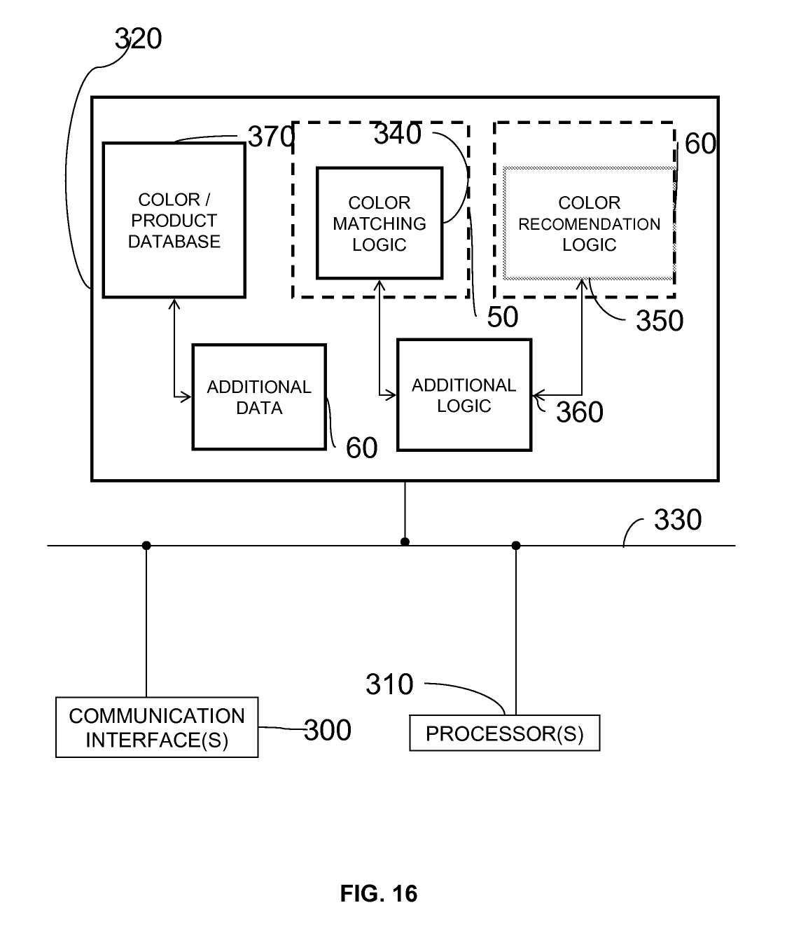

FIG. 16 illustrates color system 20 of FIG. 1 in greater detail. As depicted in FIG. 16, color system 20 may include components such as one or more communication interface(s) 300, a processor 310 and a data storage 320, all tied together via a system bus or other mechanism 330.

Note that components depicted in FIG. 16 are shown for purpose of example only and variations are possible. For example, components illustrated in FIG. 16 may be located within a single functional unit or a plurality of functional units. In this regard, for example, data storage 320 may instead be located in a physically separate location from processor 310, with a means for connecting the data storage and the processor. Alternatively, data storage 320 may be implemented using a storage area network (SAN), remote servers or databases and/or a cloud computing or data storage environment. Similarly, the logic functions could be carried out by a single processor or could be divided over distinct entities located in the same functional unit or in physically separate units. Further, system 20 may include other components in addition to those depicted in FIG. 16.

Processor 310 may be one or more general purpose processors (such as Intel Pentium class processors or better) and/or dedicated processors (such as digital signal processors), and data storage 320 may be any sort of storage, whether volatile and/or nonvolatile. Data storage 320 may hold program logic (e.g., machine language instructions) executable by processor 310 to carry out various functions described herein and/or to store data used by the program logic.

As shown in FIG. 16, data storage 320 may include color-matching section 50 holding color-matching logic 340 that includes program instructions executable by the processor to carry out various matching-related functions described herein. Similarly, data storage 320 may include color-recommendation section 60 holding color-matching logic 350 including program instructions executable by the processor to carry out various color-recommendation functions described herein. In addition, data storage 320 may include additional logic 360 to carry various other functions described herein (e.g., program logic for dominant-color processing, program logic for color-categorization processing, etc.).

In one embodiment, data storage 320 may also store one or more database(s) 370 of various color-related data and item/product information that may be searched to determine products with matching or coordinating colors. Data storage may also include other additional data 380, such as data used by various program logic and/or any other data used and/or stored by color system 20. In other embodiments, some or all of the color sources may be stored remotely from color system 20 (e.g., on the Internet, on third-party private network(s) and/or on other network element(s) located on the same network as system 20). The system could access the remotely-stored color/product information via appropriate one or more of communication interface (not shown). In this regard, third-party users (e.g., retailers) may have ability to provide and update content in the product/color database.

Additional Examples and Applications

a. User Options

In other embodiments, color system 20 may provide various other ways to interact with a user such as via web-based interface. Interactive user interface may give the user additional options of: (i) managing their colors, such as uploading new colors to their “color library” to find matching items or coordinating items, (ii) “perfecting” an uploaded image, such as by using additional tools to adjust picture's contrast, brightness, etc., (ii) creating and maintaining individualized user profile, including storing user's unique color profile (skin color, eye color, hair color, and/or lip color)), user's initial and past purchases and/or searches, past color inputs, selections and/or preferences (e.g., a virtual “closet” storing user's fashion preferences), etc. Other examples are possible as well.

Any user-related data (e.g., color profiles, color libraries, etc.) could be stored, for example, as part of data 380 held in data storage 320 (as shown in FIG. 16). Additionally, color system 20 could be programmed to use individualized user profiles to automatically provide new color and/or product matches and/or recommendations to the user, such as based on the user's past purchases, color preferences, product preferences, etc. In one embodiment, users, such as retailers (or sellers) could have an option to provide access to color system 20 directly from their e-commerce web sites, such as via a plug-in. Further, in general, color system 20 may provide sellers with interactive user interface to give sellers various options, such as various options of managing their product and/color information, including (i) creating and maintaining a product library (e.g, uploading product images (which could be, e.g., color-corrected and from which colors could be extracted by the system) to their library), (ii) providing product descriptions and/or profiles, (iii) an ability to assign multiple colors to a given product, and/or other options.

b. Mobile Device Application

According to one embodiment, color system 20 may function to tailor product recommendations and matches based on a user's location, such as particular geographic location). As is typical today, many users move around carrying their mobile communication devices, such as data-enabled mobile phones, PDAs, or even laptops. In accordance with one embodiment, user's mobile device may include a client application that works in conjunction with color system 20 to provide product matches and/or recommendations based on the current geographic location of the user.

As a general matter, the client application may function to provide an indication of the location of the user's mobile device to the system. In one example, the system may use the indication of the user's geographic location to send the user coupon(s) as an incentive to buy matching and/or coordinating products from the retailer associated with the geographic location of the user.

By way of example, based on the location information provided by the user's device, the system may determine that the user is currently located in Store A that has a special arrangement with the system to provide users with discount coupons (that may be, for example, scanned from their mobile devices) as an incentive to buy Store A's products. In another example, the system could narrow down the search results or send coupons for a group of retailers located within a vicinity of the user's current geographic location (e.g., the user may be in the vicinity of Store A and Store B).

Color system 20 could also keep track of the user's purchases in one store (e.g., Store A), and automatically provide color matches and/or recommendations of products from another store in the vicinity (e.g., Store B) based on the purchases made in Store A. In one example, the color system could keep track of the user's purchases by, for example, receiving an indication from a mobile device when the user uses a discount coupon, such as when the coupon is scanned from the user device.

Alternatively or in addition to, based on the user's purchases in a given store (e.g. Store A), color system 20 could automatically provide color matches and/or color recommendations to the user from a on-line retailer. To illustrate, the user could purchase a dress at a given store, and the color system could automatically find and provide an indication of matching shoes from another retailer in the vicinity of the given store or a on-line retailer.

With the benefit of the present embodiment, the user can thus, for example, receive dynamic product matches and/or recommendations based at least in part on their current geographic location and buy products at a discounted price.

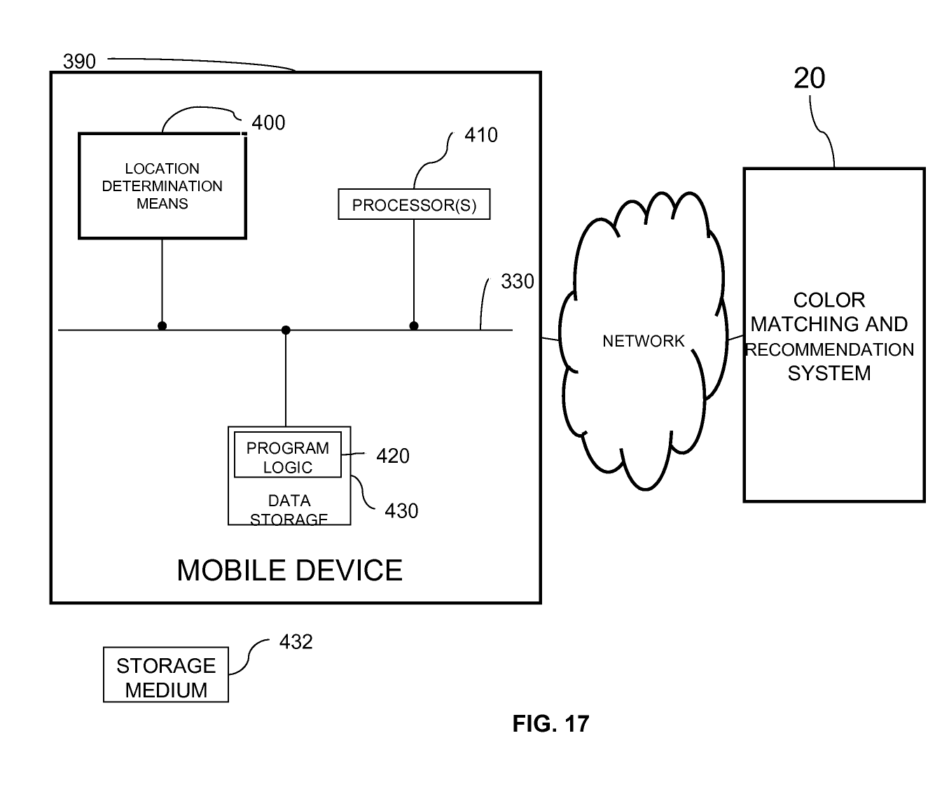

FIG. 17 depicts an example of functional components a mobile device 390 arranged to carry out various functions described herein.

In practice, mobile device 390 may be equipped with any suitable location-determination means 400, such as GPS receiver, and one or more communications interfaces (not shown) to communicate with color system 20. Alternatively, the geographic location of the mobile device may be determined using any suitable network-based positioning methods, such as triangulation and/or others. As one example, the geographic location of mobile device 390 could be obtained from a positioning system operated by a wireless carrier. As known in the art, such positioning system will typically include a mobile positioning center (MPC) that may be coupled to a position determining entity (PDE) and can provide a location of a mobile device to another requesting entity. The location could be a network-based location, such as a cell/sector (e.g., a sector pseudo-noise (PN) offset, a Cell ID, a BTS ID, etc.) in which mobile device 390 is currently operating or a specific indication of location coordinates of the device. Further, the device may include program logic 420 stored in a data storage 430 and executable by a processor 410 to carry out various client functions described herein.

In one example operation, when a user invokes the client application on a mobile device, the mobile device may be programmed to establish a communication session with color system 20 (e.g., establish a data connection via a radio network with the system (e.g., located at a remote server) as well known in the art). The device could then be programmed to provide the color system with an indication of its current geographic location. This may happen automatically (e.g., on a periodic basis) or the device may be polled by the color system to provide that information. If the device is GPS equipped, then the location may be in the form of GPS coordinates that could be sent within an HTTP message, for instance, such as during initiation of the communication session with the system (e.g., a web server).

In turn, the system could be programmed to use the geographic location of the device to determine whether the location of the user correlates to the location of any “contracted” retailers. For example, the system's database may store geographic coordinates of each “contracted retailer” and query the database and map the user's current geographic location to the location of one or more such retailers. The system could then provide the user with coupons, product recommendations, etc., tailored for that location.

c. In-Store Kiosk

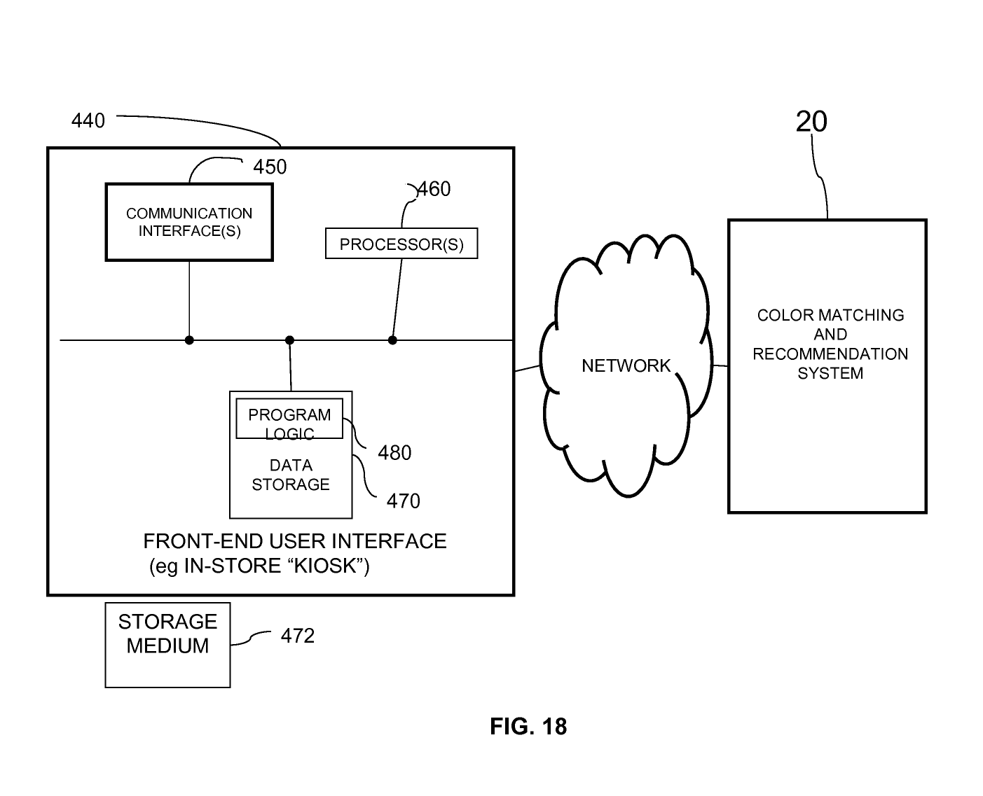

In yet another embodiment, color system 20 may include a front-end user interface (hereinafter generally referred to as a “kiosk”) that may be deployed remotely in stores or other retail locations (e.g., inside a mall) that a user could use to obtain color matches and color recommendations. FIG. 18 depicts an example of functional components of kiosk 440 arranged to carry out various functions described herein. In one example, such kiosk could be equipped with suitable communication interface(s) 450 to communicate with color system 20 via any suitable private and/or public network(s). The user could then use this kiosk to provide a color input (e.g., upload a digital image), and the system could, in turn, find and return matching and/or coordinating items (e.g., fashion-related items, home décor items, beauty-related items, etc.) back to the kiosk.

This application could be particularly important when searching for cosmetics for instance. Currently, customers shopping for make-up can try different products while in store. For example, a user can apply a foundation while in-store and examine herself in the mirror to try to determine whether the foundation matches her skin tone (or skin color) or whether a lipstick or an eye shadow coordinates well with her natural colors. As such, having an in-store kiosk could facilitate and improve finding suitable color choices for the user.

Further, one problem that may often arise in such scenario is that in-store light conditions (e.g., fluorescent lightning) can obscure the actual color of the user's skin. With the benefit of the present embodiment, the user could instead take a picture of herself under more natural light conditions (e.g., outside the store), or at the kiosk. That image could be then uploaded to the system (by the user or in-store personnel) via the kiosk to find matching and/or coordinating items. Alternatively, the kiosk may include a camera which can take a picture of the user. The picture may be uploaded by the user or automatically to the color system 20 and optionally processed by the color correction sub-system or by a color correction algorithm.

In practice, the kiosk may be equipped with different user input interfaces (not shown) to allow the user to provide color data via various means (e.g., upload a photo directly from a digital camera, a mobile phone, or via the web). Further, the kiosk may include program logic 480 stored in a data storage 470 and executable by a processor 460 to carry out various functions described herein for interaction with color system 20.

In addition, each kiosk may be associated with a unique identifier indicative of a retailer or a number of retailers (e.g., when the kiosk is provided at a mall for example), store number, etc. As such, color system 20 could identify products that can be purchased, for example, from particular retailer(s), at that particular retailer location, etc. In this regard, the kiosk could be programmed to automatically provide the unique identifier to the system.

Embodiments of the present application have been described above. Those skilled in the art will understand, however, that changes and modifications may be made to these embodiments without departing from the true scope and spirit of the present application, which is defined by the claims.

Further, the examples in the above description and figures are set forth in the context of users, such as buyers, but the described method and system could be used by any user and not only those described in the above examples. To illustrate, the system of the present application could be used by industry professionals, such as manufacturers, retailers, dye makers, etc. often need color information at different stages of product development or to make color and/or sales predictions during various seasons. Interior designers are yet another group of professionals who could benefit from the various embodiments disclosed herein.

1. A method for color recommendation, the method comprising:
receiving, by a color matching and recommendation computing device, a color input indicative of one or more colors;
selecting, by the color matching and recommendation computing device, at least one reference color from the one or more colors;
associating, by the color matching and recommendation computing device, the at least one reference color with at least one of a plurality of predefined color categories; and
identifying, by the color matching and recommendation computing device, at least one related color based on the at least one of the plurality of predefined color categories.

2. The method of claim 1, further comprising defining, by the color matching and recommendation computing device, the plurality of predefined color categories for the one or more colors within a visible spectrum.

3. The method of claim 2, wherein the defining includes further comprises:
establishing, by the color matching and recommendation computing device, a database of the one or more colors, and
defining, by the color matching and recommendation computing device, the plurality of predefined color categories based on the one or more colors in the database.

4. The method of claim 2, wherein the colors are categorized based on a combination of two or more of hue, temperature, value, or chroma.

5. The method of claim 1, wherein the at least one related color is at least one of a matching color or a coordinating color.

6-7. (canceled)

8. The method of claim 1, wherein the identifying further comprises identifying, by the color matching and recommendation computing device, the at least one related color based on a color-category descriptor uniquely identifying the at least one of the plurality of predefined color categories.

9. The method of claim 1, further comprising identifying, by the color matching and recommendation computing device, one or more items associated with the at least one related color.

10. The method of claim 9, wherein the identifying the at least one item further comprises:
receiving, by the color matching and recommendation computing device, an indication of the geographic location of a user;
identifying, by the color matching and recommendation computing device, the at least one item further based on a geographic location of the user; and
providing, by the color matching and recommendation computing device, an indication of the at least one item to a user.

11. (canceled)

12. The method of claim 10, wherein the identifying the at least one item further comprises identifying, by the color matching and recommendation computing device, the at least one item based on a user's purchase at a first retail location that is in a vicinity of the geographic location of the user.

13. The method of claim 12, wherein the identifying the at least one item further comprises identifying, by the color matching and recommendation computing device, the at least one item from a second retail location in a vicinity of the first retail location or from an on-line retailer.

14. (canceled)

15. The method of claim 1, further comprising providing, by the color matching and recommendation computing device, an indication of the at least one related color to a user.

16. The method of claim 9, wherein the at least one item further comprises at least one of a cosmetic product or a fashion product.

17. The method of claim 16, wherein the cosmetic product further comprises at least one of a foundation, powder, lipstick, or an eye shadow or wherein the fashion product further comprises at least one of an item of clothing, shoes or an accessory.

18-19. (canceled)

20. The method of claim 1, wherein each of the plurality of predefined color categories is defined based on a combination of different characteristics.

21. (canceled)

22. The method of claim 20, wherein the characteristics further comprise at least one of color temperature, color hue, color value, or color chroma.

23. The method of claim 1, further comprising color-correcting, by the color matching and recommendation computing device, the color input.

24. The method of claim 1, further comprising obtaining, by the color matching and recommendation computing device, color information from the color input, wherein the selecting is based on the obtained color information.

25. The method of claim 1, wherein the at least one reference color further comprises multiple reference colors.

26-28. (canceled)

29. The method of claim 1, wherein the at least one related color is associated at least with the same one of the plurality of predefined color categories as the reference color.

30. The method of claim 1, wherein each one of the plurality of color categories is defined based on a combination of different characteristics, and wherein the at least one related color has one or more of the same color-category characteristics as the at least one reference color.

31. The method of claim 1, wherein the at least one reference color is associated with a first predefined color category of the plurality of predefined color categories, and wherein the at least one related color is associated with a second predefined color category of the plurality of predefined color categories that is different from the first predefined color category.

32. The method of claim 31, wherein the second predefined color category comprises a complementary color.

33. The method of claim 1, wherein each of the plurality of predefined color categories is defined based on a combination of different characteristics, and wherein each of the color-category characteristics has a plurality of levels.

34. The method of claim 1, wherein the at least one reference color is a dominant color.

35. The method of claim 1, wherein the one or more colors further comprise a plurality of colors, and wherein the selecting further comprises determining, by the color matching and recommendation computing device, a dominant color from the plurality of colors.

36. The method of claim 35, wherein each of the plurality of predefined color categories is defined based on a combination of different characteristics, wherein each of the color-category characteristics has a plurality of levels, and wherein the determining further comprises determining the dominant color, by the color matching and recommendation computing device, the dominant color based on the levels of each of the category characteristic.

37. The method of claim 35, wherein the determining the dominant color further comprises assigning, by the color matching and recommendation computing device, a respective weight to each of the plurality of colors.

38. (canceled)

39. The method of claim 35, wherein the determining the dominant color further comprises determining, by the color matching and recommendation computing device, the dominant color based on at least one of a plurality of factors.

40. The method of claim 39, wherein the plurality of factors comprise a dominant presence of a color and an intensity of a color.

41. The method of claim 40, wherein the dominant presence of the color is determined based on a surface area of the color.

42-46. (canceled)

47. A method for color matching, the method comprising:
receiving, by a color matching and recommendation computing device, a color input indicative of one or more colors;
selecting, by the color matching and recommendation computing device, at least one reference color from the one or more colors; and
comparing, by the color matching and recommendation computing device, the at least one reference color to a plurality of predetermined colors to identify one or more related colors having color data closest to the at least one reference color.

48. The method of claim 47, wherein the comparing further comprises calculating, by the color matching and recommendation computing device, color-data differences between the at least one reference color and the plurality of predetermined colors to identify the one or more colors having color data closest to the at least one reference color.

49. The method of claim 47, further comprising identifying, by the color matching and recommendation computing device, at least one color from the one or more colors having the closest data that belongs to a same color family as the reference color.

50-91. (canceled)

92. A computerized method comprising:
receiving, by a color matching and recommendation computing device, a color input indicative of at least a skin color of a given person; and
automatically identifying, by the color matching and recommendation computing device, one or more related colors based at least on the skin color of the given person.

93-95. (canceled)

96. A color matching and recommendation computing apparatus, the apparatus comprising:
a processor and a memory device coupled to the processor, the processor configured to execute programmed instructions stored in the memory device comprising;
receiving a color input indicative of one or more colors,
selecting at least one reference color from the one or more colors,
associating the at least one reference color with at least one of a plurality of predefined color categories; and
identifying at least one related color based on the at least one of the plurality of predefined color categories.

97-132. (canceled)

133. The apparatus of claim 96, wherein the processor is configured to execute programmed instructions stored in the memory device further comprising defining the plurality of predefined color categories for the one or more colors within a visible spectrum.

134. The apparatus of claim 133, wherein the processor is configured to execute programmed instructions stored in the memory device for the defining further comprising:
establishing a database of the one or more colors, and
defining the plurality of predefined color categories based on the one or more colors in the database.

135. The apparatus of claim 133, wherein the colors are categorized based on a combination of two or more of hue, temperature, value, or chroma.

136. The apparatus of claim 96, wherein the at least one related color is at least one of a matching color or a coordinating color.

137. The apparatus of claim 96, wherein the processor is configured to execute programmed instructions stored in the memory device for the identifying further comprising identifying the at least one related color based on a color-category descriptor uniquely identifying the at least one of the plurality of predefined color categories.

138. The apparatus of claim 96, wherein the processor is configured to execute programmed instructions stored in the memory device further comprising identifying at one or more items associated with the at least one related color.

139. The apparatus of claim 138, wherein the processor is configured to execute programmed instructions stored in the memory device for the identifying the at least one item further comprising:
receiving an indication of the geographic location of a user;
identifying the at least one item further based on a geographic location of a user; and
providing an indication of the at least one item to the user.

140. The apparatus of claim 139, wherein the processor is configured to execute programmed instructions stored in the memory device for the identifying the at least one item further comprising identifying the at least one item based on a user's purchase at a first retail location that is in a vicinity of the geographic location of the user.

141. The apparatus of claim 140, wherein the processor is configured to execute programmed instructions stored in the memory device for the identifying the at least one item further comprising identifying the at least one item from a second retail location in a vicinity of the first retail location or from an on-line retailer.

142. The apparatus of claim 96, wherein the processor is configured to execute programmed instructions stored in the memory device further comprising providing an indication of the at least one related color to a user.

143. The apparatus of claim 138, wherein the at least one item further comprises at least one of a cosmetic product or a fashion product.

144. The apparatus of claim 143, wherein the cosmetic product further comprises at least one of a foundation, powder, lipstick, and an eye shadow or wherein the fashion product further comprises at least one of an item of clothing, shoes and an accessory.

145. The apparatus of claim 96, wherein each of the plurality of predefined color categories is defined based on a combination of different characteristics.

146. The apparatus of claim 145, wherein the characteristics further comprise at least one of color temperature, color hue, color value, or color chroma.

147. The apparatus of claim 96, wherein the processor is configured to execute programmed instructions stored in the memory device further comprising color-correcting the color input.

148. The apparatus of claim 96, wherein the processor is configured to execute programmed instructions stored in the memory device further comprising obtaining color information from the color input, wherein the selecting is based on the obtained color information.

149. The apparatus of claim 96, wherein the at least one reference color further comprises multiple reference colors.

150. The apparatus of claim 96, wherein the at least one related color is associated at least with the same one of the plurality of predefined color categories as the reference color.

151. The apparatus of claim 96, wherein each one of the plurality of color categories is defined based on a combination of different characteristics, and wherein the at least one related color has one or more of the same color-category characteristics as the at least one reference color.

152. The apparatus of claim 96, wherein the at least one reference color is associated with a first predefined color category of the plurality of predefined color categories, and wherein the at least one related color is associated with a second predefined color category of the plurality of predefined color categories that is different from the first predefined color category.

153. The apparatus of claim 152, wherein the second predefined color category comprises a complementary color.

154. The apparatus of claim 96, wherein each of the plurality of predefined color categories is defined based on a combination of different characteristics, and wherein each of the color-category characteristics has a plurality of levels.

155. The apparatus of claim 96, wherein the at least one reference color is a dominant color.

156. The apparatus of claim 96, wherein the one or more colors further comprise a plurality of colors, and wherein the selecting further comprises determining a dominant color from the plurality of colors.

157. The apparatus of claim 156, wherein each of the plurality of predefined color categories is defined based on a combination of different characteristics, wherein each of the color-category characteristics has a plurality of levels, and wherein the processor is configured to execute programmed instructions stored in the memory device for the determining the dominant color further comprising determining the dominant color based on the levels of each of the category characteristic.

158. The apparatus of claim 156, wherein the processor is configured to execute programmed instructions stored in the memory device for the determining the dominant color further comprising assigning a respective weight to each of the plurality of colors.

159. The apparatus of claim 156, wherein the processor is configured to execute programmed instructions stored in the memory device for the determining the dominant color further comprises determining the dominant color based on at least one of a plurality of factors.

160. The apparatus of claim 159, wherein the plurality of factors comprise a dominant presence of a color and an intensity of a color.

161. The apparatus of claim 160, wherein the dominant presence of the color is determined based on a surface area of the color.

162. A non-transitory computer readable medium having stored thereon instructions for color recommendation comprising machine executable code which when executed by at least one processor, causes the processor to perform steps comprising:
receiving a color input indicative of one or more colors,
selecting at least one reference color from the one or more colors,
associating the at least one reference color with at least one of a plurality of predefined color categories; and
identifying at least one related color based on the at least one of the plurality of predefined color categories.

163. The medium of claim 162, further comprising defining the plurality of predefined color categories for the one or more colors within a visible spectrum.

164. The medium of claim 163, further comprising:
establishing a database of the one or more colors, and
defining the plurality of predefined color categories based on the one or more colors in the database.

165. The medium of claim 163, wherein the colors are categorized based on a combination of two or more of hue, temperature, value, or chroma.

166. The medium of claim 162, wherein the at least one related color is at least one of a matching color or a coordinating color.

167. The medium of claim 162, wherein the identifying further comprising identifying the at least one related color based on a color-category descriptor uniquely identifying the at least one of the plurality of predefined color categories.

168. The medium of claim 162, further comprising identifying one or more item associated with the at least one related color.

169. The medium of claim 168, wherein the identifying the at least one item further comprising:
receiving an indication of the geographic location of a user;
identifying the at least one item further based on a geographic location of a user; and
providing an indication of the at least one item to the user.

170. The medium of claim 169, wherein the identifying the at least one item further comprising identifying the at least one item based on a user's purchase at a first retail location that is in a vicinity of the geographic location of the user.

171. The medium of claim 170, wherein the identifying the at least one item further comprising identifying the at least one item from a second retail location in a vicinity of the first retail location or from an on-line retailer.

172. The medium of claim 162, further comprising providing an indication of the at least one related color to a user.

173. The medium of claim 168, wherein the at least one item further comprises at least one of a cosmetic product or a fashion product.

174. The medium of claim 173, wherein the cosmetic product further comprises at least one of a foundation, powder, lipstick, and an eye shadow or wherein the fashion product further comprises at least one of an item of clothing, shoes and an accessory.

175. The medium of claim 162, wherein each of the plurality of predefined color categories is defined based on a combination of different characteristics.

176. The medium of claim 175, wherein the characteristics further comprise at least one of color temperature, color hue, color value, or color chroma.

177. The medium of claim 162, further comprising color-correcting the color input.

178. The medium of claim 162, further comprising obtaining color information from the color input, wherein the selecting is based on the obtained color information.

179. The medium of claim 162, wherein the at least one reference color further comprises multiple reference colors.

180. The medium of claim 162, wherein the at least one related color is associated at least with the same one of the plurality of predefined color categories as the reference color.

181. The medium of claim 162, wherein each one of the plurality of color categories is defined based on a combination of different characteristics, and wherein the at least one related color has one or more of the same color-category characteristics as the at least one reference color.

182. The medium of claim 162, wherein the at least one reference color is associated with a first predefined color category of the plurality of predefined color categories, and wherein the at least one related color is associated with a second predefined color category of the plurality of predefined color categories that is different from the first predefined color category.

183. The medium of claim 182, wherein the second predefined color category comprises a complementary color.

184. The medium of claim 162, wherein each of the plurality of predefined color categories is defined based on a combination of different characteristics, and wherein each of the color-category characteristics has a plurality of levels.

185. The medium of claim 162, wherein the at least one reference color is a dominant color.

186. The medium of claim 162, wherein the one or more colors further comprise a plurality of colors, and wherein the selecting further comprises determining a dominant color from the plurality of colors.

187. The medium of claim 186, wherein each of the plurality of predefined color categories is defined based on a combination of different characteristics, wherein each of the color-category characteristics has a plurality of levels, and wherein the determining the dominant color further comprising determining the dominant color based on the levels of each of the category characteristic.

188. The medium of claim 186, wherein the determining the dominant color further comprising assigning a respective weight to each of the plurality of colors.

189. The medium of claim 186, wherein the determining the dominant color further comprises determining the dominant color based on at least one of a plurality of factors.

190. The medium of claim 189, wherein the plurality of factors comprise a dominant presence of a color and an intensity of a color.

191. The medium of claim 190, wherein the dominant presence of the color is determined based on a surface area of the color.
